(19) United States
(12) Patent Application Publication
(10) Pub. No.: US 2015/0244958 A1
(43) Pub. Date: Aug. 27, 2015

(54) SOLID-STATE IMAGING DEVICE

(71) Applicant: KABUSHIKI KAISHA TOSHIBA, Tokyo (JP)

(72) Inventors: Tatsuya OHGURO, Yokohama-shi (JP); Koichi KOKUBUN, Yokohama-shi (JP)

(21) Appl. No.: 14/324,430

(22) Filed: Jul. 7, 2014

(30) Foreign Application Priority Data
Feb. 27, 2014 (JP) 2014-037317

(51) Int. Cl. H04N 5/374; H04N 9/07; H04N 9/04

(52) U.S. Cl. CPC H04N 5/374; H04N 9/045; H04N 9/07

(57) ABSTRACT

According to one embodiment, there is provided a solid-state imaging device including a plurality of pixels. Each of the plurality of pixels includes a first photoelectric conversion unit, a second photoelectric conversion unit, a multilayer interference filter, and a reflective unit. The first photoelectric conversion unit includes a photoelectric conversion film photoelectrically converting first color light. In the multilayer interference filter, first and second layers having different refractive indexes are alternately laminated. The multilayer interference filter selectively guides at least second color light of light having passed through the first photoelectric conversion unit to the second photoelectric conversion unit. The reflective unit is disposed on a side surface of the multilayer interference filter.

### CROSS-REFERENCE TO RELATED APPLICATIONS

This application is based upon and claims the benefit of priority from Japanese Patent Application No. 2014-037317, filed on Feb. 27, 2014; the entire contents of which are incorporated herein by reference.

### FIELD

Embodiments described herein relate generally to a solid-state imaging device.

### BACKGROUND

When a photoelectric conversion film disposed above a semiconductor substrate is used in a solid-state imaging device such as a CMOS image sensor, specific color light is absorbed by the photoelectric conversion film and charges corresponding to the absorbed light are generated in the photoelectric conversion film. At this time, it is preferable that the sensitivity of the photoelectric conversion film be improved.

### BRIEF DESCRIPTION OF THE DRAWINGS

FIG. 1 is a diagram illustrating the configuration of an imaging system to which a solid-state imaging device according to a first embodiment is applied;

FIG. 2 is a diagram illustrating the configuration of the imaging system to which the solid-state imaging device according to the first embodiment is applied;

FIG. 3 is a diagram illustrating the circuit configuration of the solid-state imaging device according to the first embodiment;

FIGS. 4A and 4B are diagrams illustrating the cross-sectional structure and the planar structure of the solid-state imaging device according to the first embodiment;

FIG. 5 is a diagram illustrating the planar structure of the solid-state imaging device according to the first embodiment;

FIGS. 6A to 6D are diagrams illustrating a method of manufacturing the solid-state imaging device according to the first embodiment;

FIGS. 7A to 7C are diagrams illustrating the method of manufacturing the solid-state imaging device according to the first embodiment;

FIGS. 8A and 8B are diagrams illustrating the method of manufacturing the solid-state imaging device according to the first embodiment;

FIGS. 9A and 9B are diagrams illustrating the structure of a solid-state imaging device according to a second embodiment;

FIGS. 10A to 10C are diagrams illustrating a method of manufacturing the solid-state imaging device according to the second embodiment;

FIGS. 11A and 11B are diagrams illustrating the method of manufacturing the solid-state imaging device according to the second embodiment;

FIGS. 12A and 12B are diagrams illustrating the structure of a solid-state imaging device according to a third embodiment;

FIGS. 13A to 13D are diagrams illustrating a method of manufacturing the solid-state imaging device according to the third embodiment;

FIGS. 14A and 14B are diagrams illustrating the structure of a solid-state imaging device according to a fourth embodiment;

FIGS. 15A and 15B are diagrams illustrating the structure and characteristics of a multilayer interference filter of the fourth embodiment;

FIGS. 16A and 16B are diagrams illustrating a method of manufacturing the solid-state imaging device according to the fourth embodiment;

FIGS. 17A and 17B are diagrams illustrating the structure of a solid-state imaging device according to a modification of the fourth embodiment;

FIGS. 18A and 18B are diagrams illustrating the structure of a solid-state imaging device according to another modification of the fourth embodiment;

FIG. 19 is a diagram illustrating the structure of a solid-state imaging device according to a basic mode;

FIG. 20 is a diagram illustrating the structure and characteristics of a multilayer interference filter; and

FIG. 21 is a diagram illustrating the absorption coefficient and the absorption length of an organic photoelectric conversion film according to the wavelength of light.

### DETAILED DESCRIPTION

In general, according to one embodiment, there is provided a solid-state imaging device including a plurality of pixels. Each of the plurality of pixels includes a first photoelectric conversion unit, a second photoelectric conversion unit, a multilayer interference filter, and a reflective unit. The first photoelectric conversion unit includes a photoelectric conversion film photoelectrically converting first color light. In the multilayer interference filter, first and second layers having different refractive indexes are alternately laminated. The multilayer interference filter selectively guides at least second color light of light having passed through the first photoelectric conversion unit to the second photoelectric conversion unit. The reflective unit is disposed on a side surface of the multilayer interference filter.

Exemplary embodiments of a solid-state imaging device will be explained below in detail with reference to the accompanying drawings. The present invention is not limited to the following embodiments.

### First Embodiment

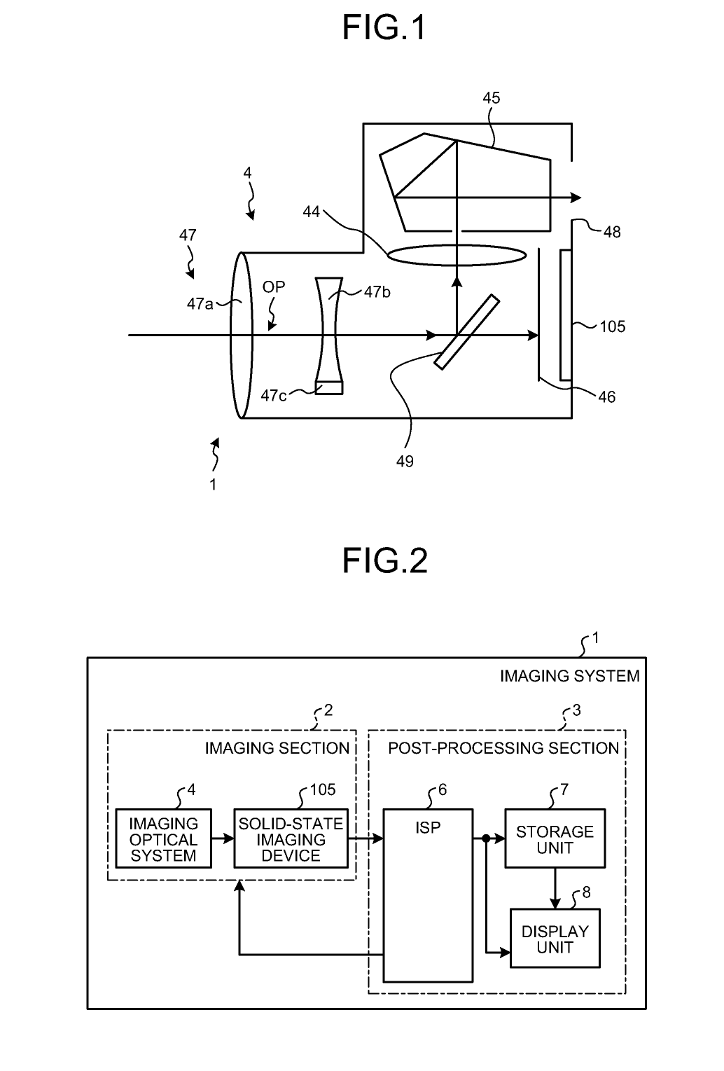

A solid-state imaging device according to a first embodiment will be described. The solid-state imaging device is applied to, for example, an imaging system that is illustrated in FIGS. 1 and 2. FIGS. 1 and 2 are diagrams illustrating the schematic configuration of the imaging system. In FIG. 1, OP denotes an optical axis.

The imaging system 1 may be, for example, a digital camera, a digital video camera, or the like, and may be an electronic device to which a camera module is applied (for example, a portable terminal with a camera or the like). As illustrated in FIG. 2, the imaging system 1 includes an imaging section 2 and a post-processing section 3. The imaging section 2 is, for example, a camera module. The imaging section 2 includes an imaging optical system 4 and a solid-state imaging device 105. The post-processing section 3 includes an ISP (Image Signal Processor) 6, a storage unit 7, and a display unit 8.

The imaging optical system 4 includes a photographing lens 47, a half mirror 49, a mechanical shutter 46, a lens 44, a prism 45, and a finder 48. The photographing lens 47 includes photographing lenses 47a and 47b, a diaphragm (not illustrated), and a lens driving mechanism 47c. The diaphragm is disposed between the photographing lenses 47a and 47b, and adjusts the amount of light that is guided to the photographing lens 47b. Meanwhile, a case in which the photographing lens 47 includes two photographing lenses 47a and 47b is exemplified in FIG. 1, but the photographing lens 47 may include more than two photographing lenses.

The solid-state imaging device 105 is disposed on an predicted image forming plane of the photographing lens 47. For example, the photographing lens 47 refracts incident light, guides the light to an imaging surface of the solid-state imaging device 105 via the half mirror 49 and the mechanical shutter 46, and forms an image of an object on the imaging surface of the solid-state imaging device 105. The solid-state imaging device 105 generates image signals corresponding to the image of the object.

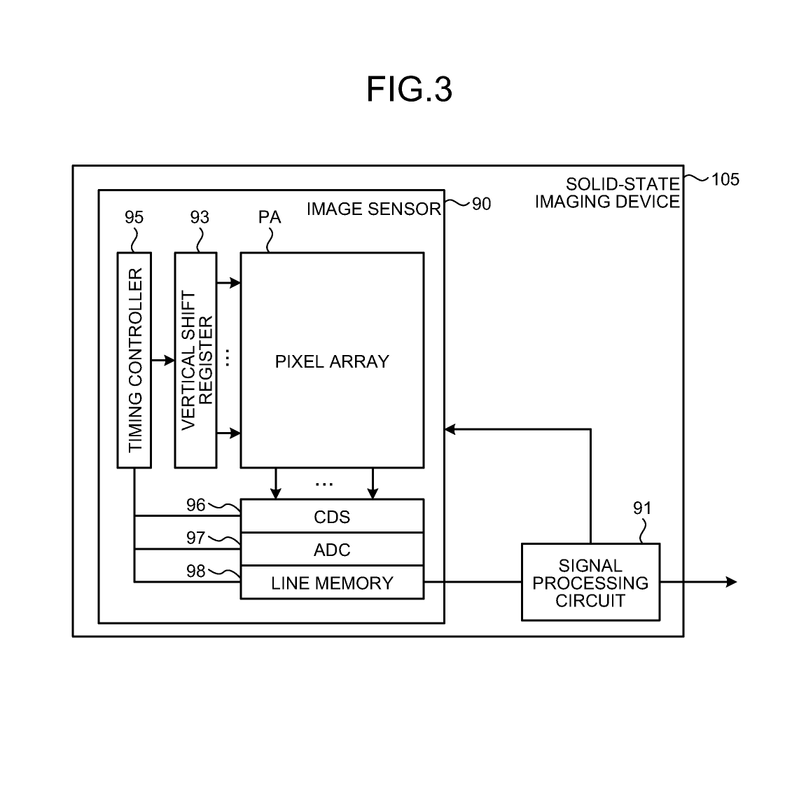

As illustrated in FIG. 3, the solid-state imaging device 105 includes an image sensor 90 and a signal processing circuit 91. FIG. 3 is a diagram illustrating the circuit configuration of the solid-state imaging device. The image sensor 90 may be, for example, a CMOS image sensor and may be a CCD image sensor. The image sensor 90 includes a pixel array PA, a vertical shift register 93, a timing controller 95, a correlation double sampling unit (CDS) 96, an analog-digital converter (ADC) 97, and a line memory 98.

A plurality of pixels are two-dimensionally arrayed in the pixel array PA. Each pixel generates an image signal corresponding to the amount of light incident on each pixel. The generated image signals are read to the CDS 96 by the timing controller 95 and the vertical shift register 93 and are converted into image data through the CDS 96 and the ADC 97, and the image data are output to the signal processing circuit 91 via the line memory 98. Signal processing is performed in the signal processing circuit 91. The image data, which have been subjected to the signal processing, are output to the ISP 6.

Here, when the solid-state imaging device 105 is a solid-state imaging device that takes a color image, various structures are considered as a color array of the plurality of pixels to improve color reproducibility of the image signals that are obtained by the solid-state imaging device 105.

For example, a solid-state imaging device where each pixel is provided with a color filter and the array of a plurality of color filters of a plurality of pixels is a Bayer array is known. Since a signal corresponding to one color is received by one pixel in this structure, there is a possibility that a light receiving area may be decreased to lower sensitivity when a pixel size is reduced due to the increase of the number of pixels in a predetermined area.

Meanwhile, in order to ensure the light receiving area of a photoelectric conversion unit for each color even though the number of pixels in a predetermined area is increased, it is effective that one pixel is designed to photoelectrically convert signals of a plurality of colors. For example, it is considered that an organic photoelectric conversion film (B film) having a function of photoelectrically converting blue wavelength light, an organic photoelectric conversion film (G film) having a function of photoelectrically converting green wavelength light, and an organic photoelectric conversion film (R film) having a function of photoelectrically converting red wavelength light are laminated in one pixel of the solid-state imaging device. In this structure, for the extraction of charges that are generated by the photoelectric conversion of each organic photoelectric conversion film, a transparent pixel electrode film comes into contact with the lower surface of the pixel and charges are extracted to a charge holding unit (for example, a storage diode) of a semiconductor substrate from the pixel electrode film through a plug electrode. That is, for the achievement of this structure, it is necessary to form, in an organic film, a contact hole into which the plug electrode is to be inserted. However, since it is difficult to perform the micromachining of the organic film, it is difficult to put this structure to practical use.

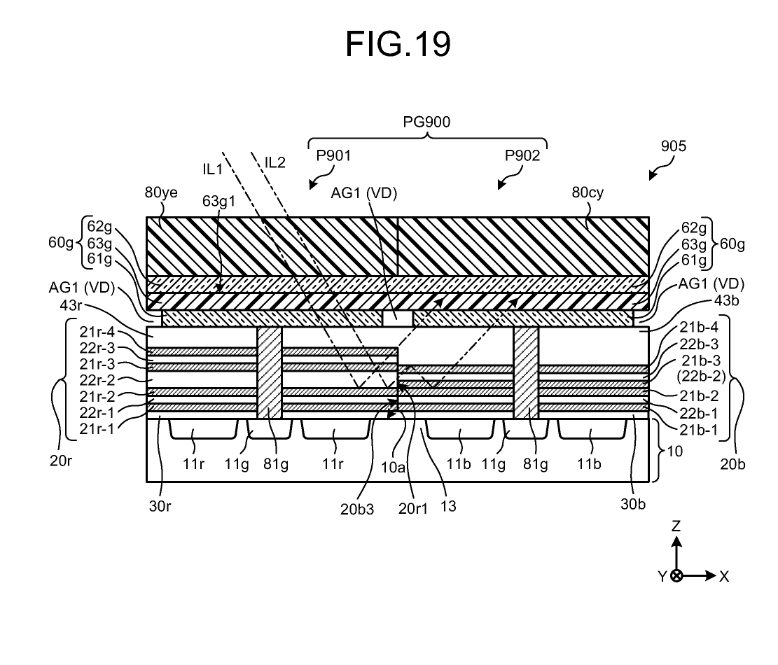

In contrast, in a basic mode, the respective layers positioned below the uppermost organic photoelectric conversion film are made of an inorganic material as illustrated in FIG. 19. FIG. 19 is a diagram illustrating the structure of a solid-state imaging device 905 according to a basic mode. In FIG. 19, a direction perpendicular to a light receiving surface 63g1 of a photoelectric conversion film 63g is referred to as a Z direction and two directions orthogonal to each other in a plane perpendicular to the Z direction are referred to as an X direction and a Y direction.

In the solid-state imaging device 905, a unit pixel group PG900 including two pixels P901 and P902 is arrayed two-dimensionally (in the X direction and the Y direction) in a pixel array PA (see FIG. 3). Each of the two pixels P901 and P902 corresponds to two colors. For example, in FIG. 19, the pixel P901 corresponds to green (G) and red (R) and the pixel P902 corresponds to green (G) and blue (B). That is, the unit pixel group PG900 corresponds to four colors (Gr, R, Gb, B) of a Bayer array.

The pixel P901 includes a charge holding unit 11g, a photoelectric conversion unit (second photoelectric conversion unit) 11r, a multilayer interference filter 20r, an interlayer insulating film 30r, an insulating film 43r, a photoelectric conversion unit (first photoelectric conversion unit) 60g, a contact plug 81g, and a color filter 80ye.

The charge holding unit 11g is disposed in a well region 13 of a semiconductor substrate 10. The well region 13 is made of a semiconductor (for example, silicon) that contains a first conductive type (for example, P type) impurity with a low concentration. The P type impurity is, for example, boron. The charge holding unit 11g is made of a semiconductor (for example, silicon) that contains a second conductive type (for example, N type) impurity, of which the conductive type is opposite to the first conductive type, with a concentration higher than the concentration of the first conductive type impurity of the well region 13. The N type impurity is, for example, phosphorus or arsenic.

The charge holding unit 11g holds charges that are transferred through the contact plug 81g. The charge holding unit 11g is, for example, a storage diode. The charge holding unit 11g converts charges into a voltage. An amplification transistor (not illustrated) outputs a signal, which corresponds to the converted voltage, to a signal line.

The interlayer insulating film 30r is provided between the multilayer interference filter 20r and the semiconductor substrate 10. The contact plug 81g penetrates the interlayer insulating film 30r. Meanwhile, a light shielding film (for example, a metal film), which shields the charge holding unit 11g, may be formed between the multilayer interference filter 20r and the semiconductor substrate 10 in a pattern that corresponds to the upper surface of the charge holding unit 11g.

The photoelectric conversion unit 11r is disposed in the well region 13 of the semiconductor substrate 10. The photoelectric conversion unit 11r is made of a semiconductor (for example, silicon) that contains the second conductive type (for example, N type) impurity with a concentration higher than the concentration of the first conductive type impurity of the well region 13. The photoelectric conversion unit 11r receives light, which has passed through the multilayer interference filter 20r and corresponds to a red wavelength region, and generates charges corresponding to the received light. The photoelectric conversion unit 11r functions as a photodiode together with, for example, the well region 13, generates charges by photoelectrically converting the received light, and stores the generated charges. The charges, which are stored in the photoelectric conversion unit 11r, are transferred to a floating diffusion (not illustrated) by a transfer transistor (not illustrated). The floating diffusion converts the transferred charges into a voltage. The amplification transistor (not illustrated) outputs a signal, which corresponds to the converted voltage, to a signal line.

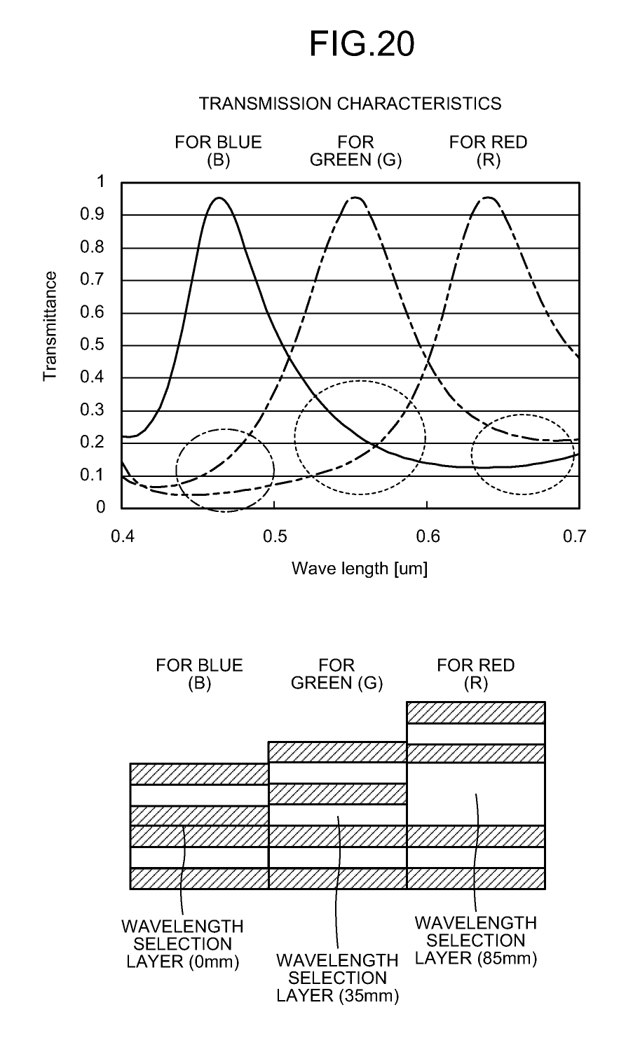

The multilayer interference filter 20r is disposed between the photoelectric conversion unit 60g and the photoelectric conversion unit 11r. Accordingly, the multilayer interference filter 20r selectively guides light, which corresponds to a red wavelength region, of light, which has passed through the photoelectric conversion unit 60g, (that is, light after light corresponding to a green wavelength region has been absorbed) to the photoelectric conversion unit 11r. The multilayer interference filter 20r is made of an inorganic material. The multilayer interference filter 20r is, for example, a photonic crystal type multilayer interference filter for red (R) in which inorganic materials (a low refractive index material and a high refractive index material) illustrated in FIG. 20 are laminated. FIG. 20 is a diagram illustrating the structure and characteristics of the multilayer interference filter.

Specifically, first insulating layers 21r-1, 21r-2, 21r-3, and 21r-4 and second insulating layers 22r-1, 22r-2, and 22r-3 are alternately laminated a plurality of time in the multilayer interference filter 20r. The refractive indexes of the first insulating layers 21r-1 to 21r-4 are higher than the refractive indexes of the second insulating layers 22r-1 to 22r-3. The first insulating layers 21r-1 to 22r-4 are made of, for example, titanium oxide (TiO₂, having a refractive index of 2.5). The second insulating layers 22r-1 to 21r-3 are made of, for example, silicon oxide (SiO₂, having a refractive index of 1.45).

The respective first insulating layers 21r-1 to 21r-4 have similar thickness. The respective second insulating layers 22r-1 and 22r-3 have similar thickness. Meanwhile, the thickness of the second insulating layer 22r-2 is larger than the thicknesses of the other second insulating layers 22r-1 and 22r-3. In the following description, the second insulating layer 22r-2 may also be particularly referred to as a wavelength selection layer 22r-2.

The insulating film 43r covers the multilayer interference filter 20r. The insulating film 43r is made of, for example, silicon oxide. The upper surface of the insulating film 43r is flattened. Accordingly, it is possible to provide a flat surface to a pixel electrode film 61g.

The photoelectric conversion unit 60g includes the pixel electrode film 61g, a photoelectric conversion film 63g, and a common electrode film 62g. In the photoelectric conversion unit 60g, the photoelectric conversion film 63g is interposed between the common electrode film 62g and the pixel electrode film 61g in the Z direction. The common electrode film 62g covers the main surface of the photoelectric conversion film 63g opposite to the photoelectric conversion unit 11r. The pixel electrode film 61g covers the main surface of the photoelectric conversion film 63g facing the photoelectric conversion unit 11r.

The pixel electrode film 61g covers the insulating film 43r. The pixel electrode film 61g functions as a pixel electrode that collects charges generated by the photoelectric conversion film 63g. The pixel electrode film 61g is connected to the charge holding unit 11g through the contact plug 81g. The pixel electrode film 61g is made of, for example, a transparent conductive material, such as ITO or ZnO. The pixel electrode film 61g is electrically insulated from a pixel electrode film 61g of the other pixel (for example, the pixel P902) through an air gap structure AG1. In the air gap structure AG1, a void VD is filled with air or predetermined gas. Meanwhile, the pixel electrode film 61g may be electrically insulated from the pixel electrode film 61g of the other pixel through an insulating film instead of the air gap structure AG1.

The photoelectric conversion film 63g covers the pixel electrode film 61g. The photoelectric conversion film 63g absorbs light, which corresponds to a green wavelength region, of the received light (that is, light having passed through the color filter 80ye) and generates charges corresponding to the absorbed light. The photoelectric conversion film 63g is, for example, an organic photoelectric conversion film, and is made of an organic material having a property that absorbs light corresponding to a green wavelength region and transmits light corresponding to other wavelength regions (for example, light corresponding to a red wavelength region).

The common electrode film 62g covers the photoelectric conversion film 63g. The common electrode film 62g applies a bias voltage, which is supplied from the outside, to the photoelectric conversion film 63g. Accordingly, charges, which are generated by the photoelectric conversion film 63g, are easily collected by the pixel electrode film 61g. The common electrode film 62g is made of, for example, a transparent conductive material, such as ITO or ZnO.

The contact plug 81g penetrates the multilayer interference filter 20r so as to electrically connect the pixel electrode film 61g to the charge holding unit 11g. Accordingly, the contact plug 81g transfers the charges, which are collected by the pixel electrode film 61g, to the charge holding unit 11g. The contact plug 81g is made of metal, and is made of a material that contains at least one of, for example, Al, Ag, Cu, Ta, W, Mo, and Ti as a main component.

The color filter 80ye is disposed on one side of the photoelectric conversion unit 60g opposite to the photoelectric conversion unit 11r. For example, the color filter 80ye is disposed on the common electrode film 62g. The color filter 80ye is, for example, a yellow color filter, and is made of, for example, an organic material containing a yellow pigment. Accordingly, the color filter 80ye selectively guides light, which corresponds to green and red wavelength regions, of incident light to the photoelectric conversion film 63g of the photoelectric conversion unit 60g. Further, since unnecessary light, which enters from the below, can be absorbed by the color filter 80ye, it is possible to suppress the reflection of the unnecessary light toward the object from the solid-state imaging device 905.

The pixel P902 is a pixel that is adjacent to the pixel P901. The basic structure of the pixel P902 is similar to that of the pixel P901, but the pixel P902 is different from the pixel P901 in terms of the following.

The pixel P902 includes a photoelectric conversion unit 11b, an insulating film 43b, a multilayer interference filter 20b, and a color filter 80cy instead of the photoelectric conversion unit 11r, the insulating film 43r, the multilayer interference filter 20r, and the color filter 80ye.

The photoelectric conversion unit 11b is disposed in the well region 13 of the semiconductor substrate 10. The photoelectric conversion unit 11b is made of a semiconductor (for example, silicon) that contains the second conductive type (for example, N type) impurity with a concentration higher than the concentration of the first conductive type impurity of the well region 13. The photoelectric conversion unit 11b receives light, which has passed through the multilayer interference filter 20b and corresponds to a blue wavelength region, and generates charges corresponding to the received light. The photoelectric conversion unit 11b functions as a photodiode together with, for example, the well region 13, generates charges by photoelectrically converting the received light, and accumulates the generated charges. The charges, which are accumulated in the photoelectric conversion unit 11b, are transferred to a floating diffusion (not illustrated) by a transfer transistor (not illustrated). The floating diffusion converts the transferred charges into a voltage. The amplification transistor (not illustrated) outputs a signal, which corresponds to the converted voltage, to a signal line.

The multilayer interference filter 20b is disposed between the photoelectric conversion unit 60g and the photoelectric conversion unit 11b. Accordingly, the multilayer interference filter 20b selectively guides light, which corresponds to a blue wavelength region, of light, which has passed through the photoelectric conversion unit 60g, (that is, light after light corresponding to a green wavelength region has been absorbed) to the photoelectric conversion unit 11b. The multilayer interference filter 20b is made of an inorganic material. The multilayer interference filter 20b is, for example, a photonic crystal type multilayer interference filter for blue (B) in which inorganic materials (a low refractive index material and a high refractive index material) illustrated in FIG. 20 are laminated.

Specifically, first insulating layers 21b-1, 21b-2, 21b-3, and 21b-4 and second insulating layers 22b-1, 22b-2, and 22b-3 are alternately laminated a plurality of times in the multilayer interference filter 20b. The refractive indexes of the first insulating layers 21b-1 to 21b-4 are higher than the refractive indexes of the second insulating layers 22b-1 to 22b-3. The first insulating layers 21b-1 to 21b-4 are made of, for example, titanium oxide (TiO₂, having a refractive index of 2.5). The second insulating layers 22b-1 to 22b-3 are made of, for example, silicon oxide (SiO₂, having a refractive index of 1.45). Meanwhile, it can be regarded that the second insulating layer 22b-2 having a thickness of 0 nm is virtually present between the first insulating layers 21b-2 and 21b-3.

The respective first insulating layers 21b-1 to 21b-4 have similar thickness. The respective second insulating layers 22b-1 and 22b-3 have similar thickness. Meanwhile, the thickness of the second insulating layer 22b-2 is smaller than the thicknesses of the other second insulating layers 22b-1 and 22b-3, and is 0 nm. In the following description, the virtual second insulating layer 22b-2 may also be particularly referred to as a wavelength selection layer 22b-2.

Here, the transmission band of the multilayer interference filters 20r and 20b are changed by the change of the thicknesses of the wavelength selection layers 22r-2 and 22b-2 while the thicknesses of the corresponding insulating layers of the multilayer interference filters 20r and 20b except for the wavelength selection layers 22r-2 and 22b-2 are set to be substantially equal to each other. For example, a case in which the first insulating layers 21r-1 to 21r-4 and 21b-1 to 21b-4 are made of TiO₂ (having a refractive index of 2.5) and the second insulating layers 22r-1 to 22r-3 and 22b-1 to 22b-3 are made of SiO₂ (having a refractive index of 1.45) is considered. In this case, when the thicknesses of the wavelength selection layers 22r-2 and 22b-2 are set to 85 nm and 0 nm, respectively, and the optical thicknesses of the other insulating layers 21r-1 to 21r-4, 22r-1, 22r-3, 21b-1 to 21b-4, 22b-1, and 22b-3 are set to a quarter of the center wavelength (for example, 550 nm) in the multilayer interference filters 20r and 20b, the multilayer interference filter 20r has a peak of spectral transmittance in a red wavelength band and the multilayer interference filter 20b has a peak of spectral transmittance in a blue wavelength band.

The color filter 80cy is disposed on one side of the photoelectric conversion film 63g opposite to the photoelectric conversion unit 11b. For example, the color filter 80cy is disposed on the common electrode film 62g. The color filter 80cy is, for example, a cyan color filter, and is made of, for example, an organic material containing a cyan pigment. Accordingly, the color filter 80cy selectively guides light, which corresponds to green and blue wavelength regions, of incident light to the photoelectric conversion film 63g of the photoelectric conversion unit 60g. Further, since unnecessary light, which enters from the below, can be absorbed by the color filter 80cy,, it is possible to suppress the reflection of the unnecessary light toward the object from the solid-state imaging device 905.

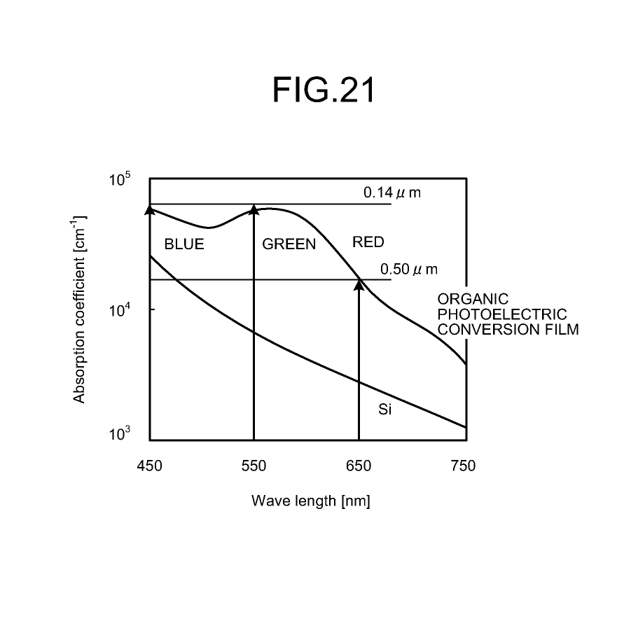

When an organic photoelectric conversion film is used in the solid-state imaging device 905, light having a specific color is absorbed by the organic photoelectric conversion film and charges corresponding to the absorbed light are generated in the organic photoelectric conversion film. At this time, as illustrated in FIG. 21, it is possible to calculate a relationship between the thickness and the light absorptivity of the organic photoelectric conversion film, which are preferable for sufficient photoelectric conversion, from an absorption coefficient (=1/(absorption length)) corresponding to the wavelength of light to be absorbed. FIG. 21 is a diagram illustrating the absorption coefficient and the absorption length of the organic photoelectric conversion film according to the wavelength of light. For example, when the thickness of the organic photoelectric conversion film is 0.5 μm, the absorptivity of the organic photoelectric conversion film is 97% in a blue wavelength band and a green wavelength band and is 63% in a red wavelength band. In order to read electrons or holes, which are generated in the organic photoelectric conversion film, as signals, it is necessary to interpose the organic photoelectric conversion film between two electrode films (a pixel electrode film and a common electrode film) and to apply a predetermined voltage between the two electrode films. For example, when the thickness of the organic photoelectric conversion film is 0.5 μm that allows the above-mentioned light absorptivity to be achieved, 10 V is applied as the predetermined voltage.

However, when the solid-state imaging device using an organic photoelectric conversion film is mounted on a portable device (for example, a smart phone or a mobile phone), a voltage for the solid-state imaging device is required to be reduced. For example, when a power supply voltage is lowered to 3 V, the thickness of the organic photoelectric conversion film generating an equivalent electric field allowing the charges, which are generated by the organic photoelectric conversion film, to be collected to the pixel electrode film is 0.16 μm. Here, when the thickness of the organic photoelectric conversion film is set to this thickness and the absorptivity of the organic photoelectric conversion film is calculated, the absorptivity of the organic photoelectric conversion film is lowered to 68% in a blue wavelength band and a green wavelength band and is lowered to 27% in a red wavelength band. In other words, this means that the organic photoelectric conversion film transmits 32% of light in a blue wavelength band and a green wavelength band without absorbing 32% of light and transmits 73% of light in a red wavelength band without absorbing 73% of light. That is, when the organic photoelectric conversion film is made thin to meet a demand for the reduction of a voltage, it is preferable that light be efficiently guided to the organic photoelectric conversion film and the sensitivity of the organic photoelectric conversion film be improved.

In the basic mode, as illustrated in FIG. 19, the photonic crystal type multilayer interference filters 20b and 20r are disposed below the photoelectric conversion film 63g, which is made of an organic material, as color filters. Since the multilayer interference filters 20b and 20r are reflection-type filters, the multilayer interference filters 20b and 20r can reflect light corresponding to other wavelength regions except for light corresponding to a wavelength region to be transmitted.

For example, since the wavelength region of light, which is to be transmitted by the multilayer interference filter 20r, is a red wavelength region when an organic photoelectric conversion film, which photoelectrically converts light corresponding to a green wavelength region, is used as the photoelectric conversion film 63g made of an organic material, the multilayer interference filter 20r can reflect light corresponding to a green wavelength region as illustrated so as to be surrounded by a dotted line in the transmission characteristics of FIG. 20 and guide the light, which corresponds to a green wavelength region, to the photoelectric conversion film 63g made of an organic material. Likewise, since the wavelength region of light, which is to be transmitted by the multilayer interference filter 20b, is a blue wavelength region, the multilayer interference filter 20b can reflect light corresponding to a green wavelength region as illustrated so as to be surrounded by a one-dot chain line in the transmission characteristics of FIG. 20 and guide the light, which corresponds to a green wavelength region, to the photoelectric conversion film 63g made of an organic material.

However, since signals leak to adjacent pixels through the side surfaces of the multilayer interference filters 20r and 20b when the light corresponding to a green wavelength region is reflected by the multilayer interference filters 20r and 20b, there is a possibility that the mixing of colors may more frequently occur between the pixels. When the mixing of colors more frequently occurs between the pixels as for the light corresponding to a green wavelength region, the amount of light, which can be reflected and guided to the photoelectric conversion film 63g made of an organic material in the same pixel, is likely to be reduced.

For example, there is a possibility that light IL1, which is incident on the pixel P901, is multiply reflected in the multilayer interference filter 20r and then enters the photoelectric conversion film 63g of the adjacent pixel P902 through a side surface 20r1 of the multilayer interference filter 20r as illustrated in FIG. 19 by a one-dot chain line arrow. Alternatively, for example, there is a possibility that light IL2, which is incident on the pixel P901, is multiply reflected in the multilayer interference filter 20r and then enters the photoelectric conversion film 63g after passing through the side surface 20r1 of the multilayer interference filter 20r and being further multiply reflected in the multilayer interference filter 20b of the adjacent pixel P902 as illustrated in FIG. 19 by a two-dot chain line arrow. This tendency becomes remarkable when the inclination angles of the light IL1 and the light IL2 incident on the pixel P901 with respect to the Z direction are large.

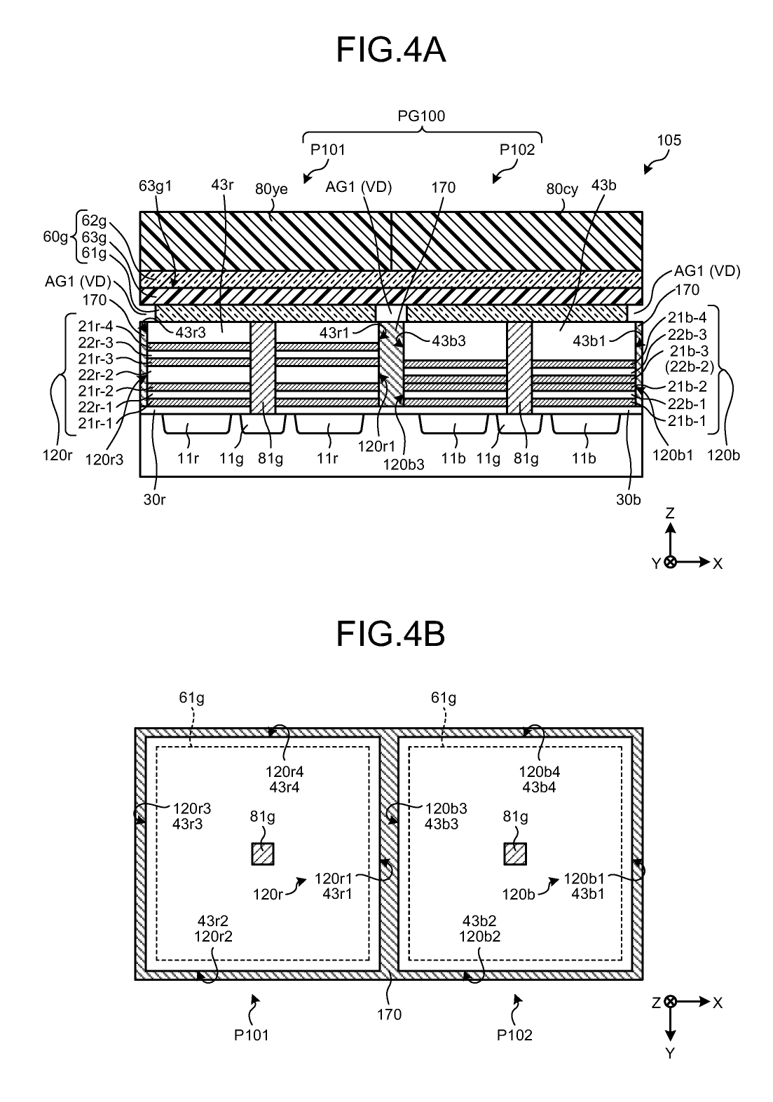

Therefore, in the first embodiment, a reflective unit 170 is disposed on side surfaces of multilayer interference filters 120r and 120b in the solid-state imaging device 105 as illustrated in FIGS. 4A and 4B to suppress the mixing of colors between pixels. FIG. 4A is a diagram illustrating the cross-sectional structure of the solid-state imaging device 105 that is cut perpendicular to the Y direction, and FIG. 4B is a diagram illustrating the planar structure of the solid-state imaging device 105 that is cut perpendicular to the Z direction at Z positions corresponding to the multilayer interference filters 120r and 120b. Portions different from the basic mode will be mainly described below.

In the solid-state imaging device 105, a unit pixel group PG100 is two-dimensionally arrayed in the pixel array PA (see FIG. 3) instead of the unit pixel group PG900 (see FIG. 19). The unit pixel group PG100 includes two pixels P101 and P102 instead of the two pixels P901 and P902 (see FIG. 19). The pixel P101 corresponds to green (G) and red (R), and the pixel P102 corresponds to green (G) and blue (B).

The pixel P101 includes the multilayer interference filter 120r instead of the multilayer interference filter 20r (see FIG. 19), and further includes the reflective unit 170.

In the basic mode, the side surface 20r1 of the multilayer interference filter 20r of the pixel P901 comes into contact with a side surface 20b3 of the multilayer interference filter 20b of the adjacent pixel P902 (see FIG. 19).

In contrast, in this embodiment, a side surface 120r1 of the multilayer interference filter 120r of the pixel P101 is separated from a side surface 120b3 of the multilayer interference filter 120b of the adjacent pixel P102 with the reflective unit 170 interposed therebetween.

Further, all of a side surface 120r1 corresponding to +X side, a side surface 120r2 corresponding to +Y side, a side surface 120r3 corresponding to −X side, and a side surface 120r4 corresponding to −Y side of the multilayer interference filter 120r come into contact with the reflective unit 170.

The reflective unit 170 is disposed on the side surfaces 120r1, 120r2, 120r3, and 120r4 of the multilayer interference filter 120r. The reflective unit 170 covers the side surfaces 120r1 to 120r4 of the multilayer interference filter 120r. The reflective unit 170 is disposed so as to surround the multilayer interference filter 120r when viewed in the Z direction. Accordingly, the reflective unit 170 can reflect green light multiply reflected in the multilayer interference filter 120r so that the green light is returned to the multilayer interference filter 120r from the side surfaces 120r1 to 120r4. As a result, it is possible to prevent green light from leaking to the adjacent pixel P102, and to efficiently reflect the light, which corresponds to a green wavelength region, by the multilayer interference filter 120r and the reflective unit 170 to guide the light to the photoelectric conversion film 63g of the pixel P101.

The reflective unit 170 is disposed on side surfaces 43r1 to 43r4 of the insulating film 43r. The reflective unit 170 covers the side surfaces 43r1 to 43r4 of the insulating film 43r. The reflective unit 170 is disposed so as to surround the insulating film 43r when viewed in the Z direction. Accordingly, the reflective unit 170 can reflect light, which has been reflected by the multilayer interference filter 120r and has reached the side surfaces 43r1 to 43r4 of the insulating film 43r, at the side surfaces 43r1 to 43r4 of the insulating film 43r and can guide the light to the photoelectric conversion film 63g of the pixel P101.

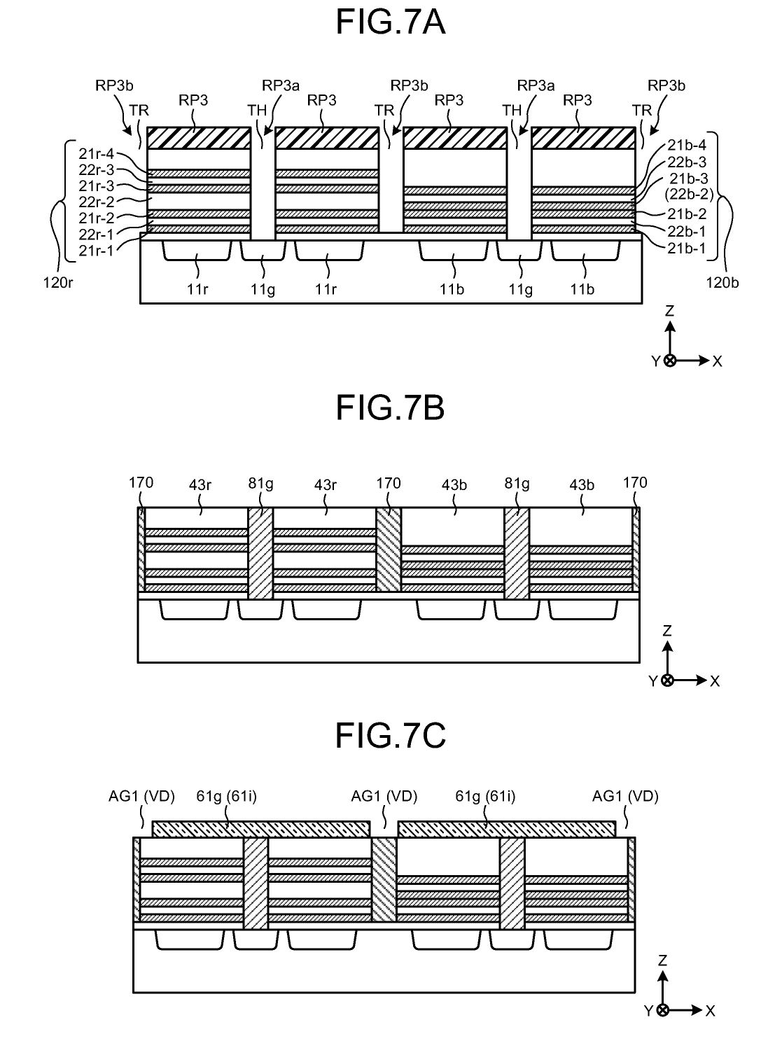

The reflective unit 170 is configured by embedding a conductive material in a trench TR (see FIG. 7A) forming the side surfaces 120r1 to 120r4 of the multilayer interference filter 120r. The conductive material includes a material that contains at least one of, for example, Al, Ag, Cu, Ta, W, Mo, and Ti as a main component. The reflective unit 170 may be made of the same material as the material of the contact plug 81g. Accordingly, the interfaces between the multilayer interference filter 120r and the reflective unit 170, that is, the side surfaces 120r1 to 120r4 of the multilayer interference filter 120r can function as reflective surfaces.

The reflective unit 170 is connected to a ground potential. The reflective unit 170 is connected to a ground line (not illustrated) in, for example, a peripheral region of the pixel array PA (see FIG. 3) through a wire (not illustrated). The contact plug 81g is positioned in the reflective unit 170 when viewed in the Z direction. Since the reflective unit 170 is connected to a ground potential, it is possible to reduce the influence of the potential of the reflective unit 170, which is caused by capacitive coupling or the like, on the signal charges that are transferred by the contact plug 81g.

Meanwhile, a case in which the contact plug 81g is disposed in the vicinity of the center of the pixel P101 when viewed in the Z direction is exemplarily illustrated in FIG. 4B. However, as long as the contact plug 81g is electrically insulated from the reflective unit 170, the contact plug 81g may be disposed in the reflective unit 170 at a position shifted from the vicinity of the center of the pixel P101.

The reflective unit 170 is configured to be electrically insulated from the pixel electrode film 61g. The reflective unit 170 has a pattern that surrounds the pixel electrode film 61g without overlapping the pixel electrode film 61g when viewed in the Z direction. That is, the reflective unit 170 has a pattern that is included in the air gap structure AG1 when viewed in the Z direction. Since the reflective unit 170 is configured to be electrically insulated from the pixel electrode film 61g, it is possible to reduce the influence of the potential of the reflective unit 170 on the signal charges that are collected by the pixel electrode film 61g.

The reflective unit 170 is configured to be electrically insulated from the semiconductor substrate 10. The reflective unit 170 is disposed above the semiconductor substrate 10 with the interlayer insulating film 30r interposed therebetween. Since the reflective unit 170 is configured to be electrically insulated from the semiconductor substrate 10, it is possible to reduce the influence of the potential of the reflective unit 170 on the potential of the semiconductor substrate 10.

Likewise, the pixel P102 includes the multilayer interference filter 120b instead of the multilayer interference filter 20b (see FIG. 19), and further includes the reflective unit 170.

Any of a side surface 120b1 corresponding to +X side, a side surface 120b2 corresponding to +Y side, a side surface 120b3 corresponding to −X side, and a side surface 120b4 corresponding to −Y side of the multilayer interference filter 120b come into contact with the reflective unit 170.

The reflective unit 170 is disposed on the side surfaces 120b1, 120b2, 120b3, and 120b4 of the multilayer interference filter 120b. The reflective unit 170 covers the side surfaces 120b1 to 120b4 of the multilayer interference filter 120b. The reflective unit 170 is disposed so as to surround the multilayer interference filter 120b when viewed in the Z direction. Accordingly, the reflective unit 170 can reflect green light multiply reflected in the multilayer interference filter 120b so that the green light is returned to the multilayer interference filter 120b from the side surfaces 120b1 to 120b4. As a result, it is possible to prevent green light from leaking to the adjacent pixel P101, and to efficiently reflect the light, which corresponds to a green wavelength region, by the multilayer interference filter 20b and the reflective unit 170 to guide the light to the photoelectric conversion film 63g of the pixel P102.

The reflective unit 170 is disposed on side surfaces 43b1 to 43b4 of the insulating film 43b. The reflective unit 170 covers the side surfaces 43b1 to 43b4 of the insulating film 43b. The reflective unit 170 is disposed so as to surround the insulating film 43b when viewed in the Z direction. Accordingly, the reflective unit 170 can reflect light, which has been reflected by the multilayer interference filter 120b and has reached the side surfaces 43b1 to 43b4 of the insulating film 43b, at the side surfaces 43b1 to 43b4 of the insulating film 43b and can guide the light to the photoelectric conversion film 63g of the pixel P102.

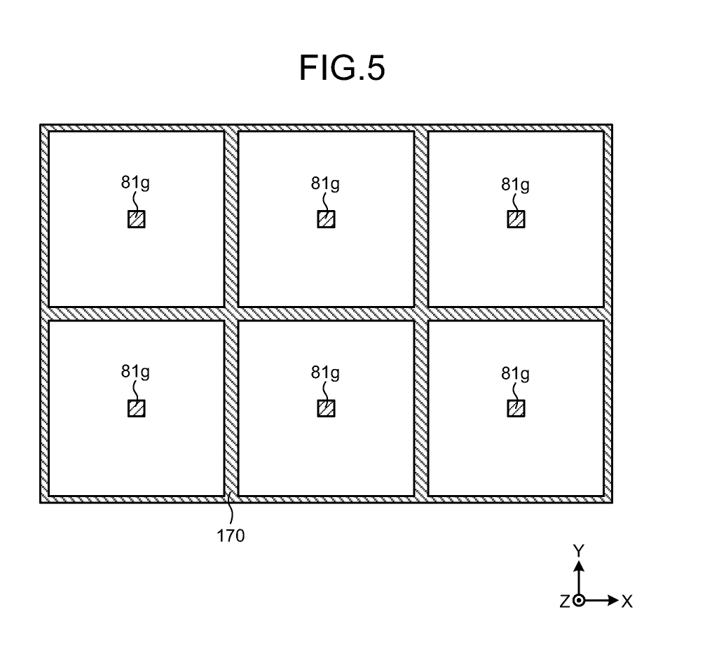

As illustrated in FIGS. 4A and 4B, the reflective unit 170 is disposed in boundary regions of the two adjacent pixels P101 and P102 and is shared between the two adjacent pixels P101 and P102. Accordingly, as illustrated in FIG. 5, the reflective unit 170 for the plurality of pixels extends in the shape of a lattice so as to define the boundaries of the pixels when viewed in the Z direction. FIG. 5 is a diagram illustrating the planar structure of the solid-state imaging device, which is viewed in the Z direction, while focusing attention on the reflective unit 170 and the contact plugs 81g. Since the reflective unit 170 for the plurality of pixels extends in the shape of a lattice so as to define the boundaries of the pixels, it is possible to ensure the light receiving area of each pixel and to efficiently suppress the mixing of colors between the pixels. Further, when the plurality of pixels are considered as a whole, it is possible to improve the stiffness of the multilayer interference filters 120r and 120b of the plurality of pixels. Accordingly, it is possible to improve the multilayer interference filters 120r and 120b of the plurality of pixels in terms of strength.

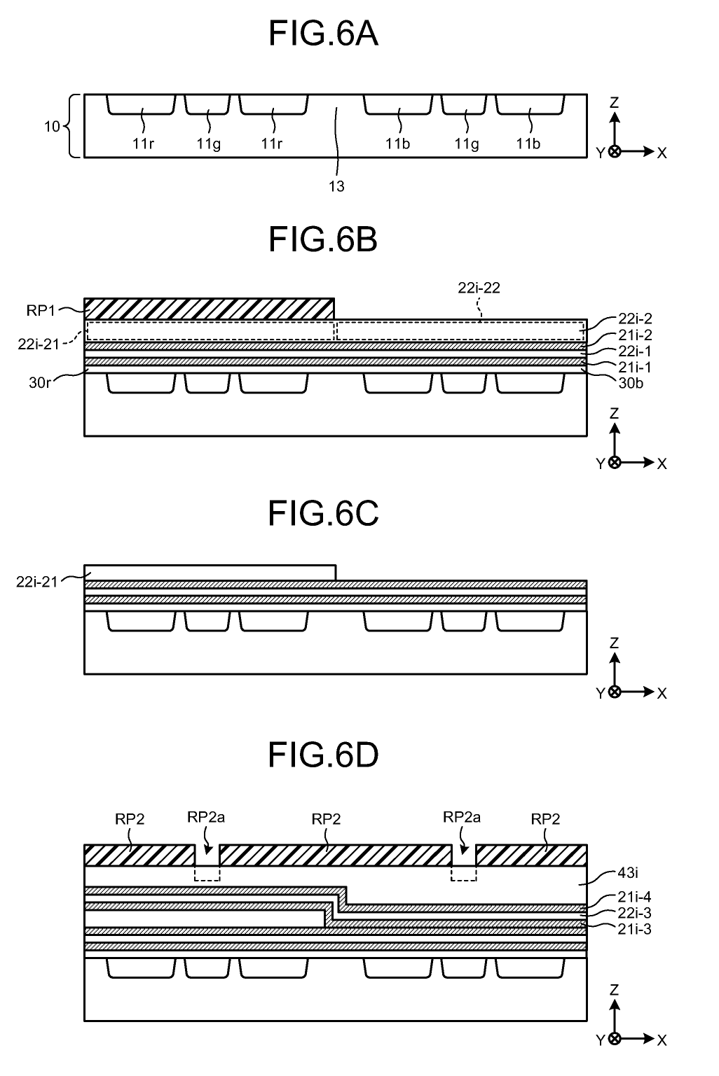

Next, a method of manufacturing the solid-state imaging device 105 will be described with reference to FIGS. 6A to 8B. FIGS. 6A to 8B are cross-sectional views illustrating processes of the method of manufacturing the solid-state imaging device 105.

In a process illustrated in FIG. 6A, the semiconductor substrate 10 is prepared and the well region 13 is formed in the semiconductor substrate 10 by an ion implantation method or the like. The well region 13 is made of a semiconductor (for example, silicon) that contains a first conductive type (for example, P type) impurity with a low concentration. The P type impurity is, for example, boron. Further, the charge holding unit 11g and the photoelectric conversion units 11r and 11b are formed in the well region 13 by an ion implantation method or the like. Each of the charge holding unit 11g and the photoelectric conversion units 11r and 11b is made of a semiconductor (for example, silicon) that contains a second conductive type (for example, N type) impurity, of which the conductive type is opposite to the first conductive type, with a concentration higher than the concentration of the first conductive type impurity of the well region 13. The N type impurity is, for example, phosphorus or arsenic.

In a process illustrated in FIG. 6B, interlayer insulating films 30r and 30b are deposited on the semiconductor substrate 10 by a CVD method or the like. Next, the formation of the respective layers, which form the multilayer interference filters 120r and 120b, is started. Specifically, a first insulating layer 21-1, a second insulating layer 22-1, a first insulating layer 21-2, and a second insulating layer 22-2 are deposited in this order by a sputtering method or the like.

The first insulating layers 21-1 and 21-2 are made of, for example, titanium oxide (TiO₂). Each of the first insulating layers 21-1 and 21-2 is formed so as to have a physical thickness that corresponds to an optical thickness of a quarter of the center wavelength (for example, 550 nm). When each of the first insulating layers 21-1 and 21-2 is made of titanium oxide (having a refractive index of 2.5), each of the first insulating layers 21-1 and 21-2 is formed so as to have a physical thickness of 55 (nm) (=550×¼× 1/2.5).

The second insulating layers 22-1 and 22-2 are made of, for example, silicon oxide (SiO₂). The second insulating layer 22-1 is formed so as to have a physical thickness that corresponds to an optical thickness of a quarter of the center wavelength (for example, 550 nm). When each of the second insulating layers 22-1 and 22-2 is made of silicon oxide (having a refractive index of 1.45), each of the second insulating layers 22-1 and 22-2 is formed so as to have a physical thickness of 94.8 (nm) (=550×¼× 1/1.45). The second insulating layer 22-2 forming the wavelength selection layer 22r-2 is formed so as to have a physical thickness of the thickness (for example, 85 nm) corresponding to a red wavelength band.

Further, a resist pattern RP1 covering a portion 22-21 of the second insulating layer 22-2, which corresponds to portion above the photoelectric conversion unit 11r, is formed by a lithography method.

In a process illustrated in FIG. 6C, a portion 22-22 of the insulating layer, which corresponds to portion above the photoelectric conversion unit 11b, is etched up to a thickness (for example, 0 nm) corresponding to a blue wavelength band by a dry etching method while the resist pattern RP1 is used as a mask. After that, the resist pattern RP1 is removed. That is, the portion 22-22 of the second insulating layer 22-2 is removed and the portion 22-21 remains.

In a process illustrated in FIG. 6D, a first insulating layer 21-3, a second insulating layer 22-3, and a first insulating layer 21-4 are deposited in this order by a sputtering method or the like.

The first insulating layers 21-3 and 21-4 are made of, for example, titanium oxide (TiO₂). Each of the first insulating layers 21-3 and 21-4 is formed so as to have a physical thickness that corresponds to an optical thickness of a quarter of the center wavelength (for example, 550 nm). When each of the first insulating layers 21-3 and 21-4 is made of titanium oxide (having a refractive index of 2.5), each of the first insulating layers 21-3 and 21-4 is formed so as to have a physical thickness of 55 (nm) (=550×¼× 1/2.5).

The second insulating layer 22-3 is made of, for example, silicon oxide (SiO₂). The second insulating layer 22-3 is formed so as to have a physical thickness that corresponds to an optical thickness of a quarter of the center wavelength (for example, 550 nm). When the second insulating layer 22-3 is made of silicon oxide (having a refractive index of 1.45), the second insulating layer 22-3 is formed so as to have a physical thickness of 94.8 (nm) (≈550×¼× 1/1.45).

Further, an insulating film 43i covering the first insulating layer 21-4 is made of, for example, SiO₂ and is formed through deposition by a CVD method or the like. The insulating film 43i is flattened by a CMP method.

Next, a resist pattern RP2 is formed on the insulating film 43i. The resist pattern RP2 includes openings RP2a formed in regions (see FIG. 4B) where the contact plugs 81g are to be disposed. Further, the insulating film 43i is etched by a dry etching method while the resist pattern RP2 is used as a mask. Accordingly, holes having a predetermined depth (illustrated in FIG. 6D by a dotted line) are formed in the regions of the insulating film 43i where the contact plugs 81g are to be disposed. This predetermined depth is a depth that is experimentally obtained in advance as a depth enough to allow the surfaces of the interlayer insulating films 30r and 30b to be exposed to the outside in a region where the reflective unit 170 is to be disposed when the surfaces of the charge holding units 11g are exposed to the outside in the regions where the contact plugs 81g are to be disposed in a subsequent process. After that, the resist pattern RP2 is removed.

In a process illustrated in FIG. 7A, a resist pattern RP3 is formed on the insulating film 43i. The resist pattern RP3 includes openings RP3a formed in the regions (see FIG. 4B) where the contact plugs 81g are to be disposed and an opening RP3b formed in the region (see FIG. 4B) where the reflective unit 170 is to be disposed. Further, the insulating film 43i, the first insulating layer 21-4, the second insulating layer 22-3, the first insulating layer 21-3, the second insulating layer 22-2, the first insulating layer 21-2, the second insulating layer 22-1, the first insulating layer 21-1, and the interlayer insulating films 30r and 30b are etched by a dry etching method while the resist pattern RP3 is used as a mask. Accordingly, through holes TH, which pass through the respective layers to the surfaces of the charge holding units 11g from the upper surface of the insulating film 43i, are formed and a trench TR having a depth, which reaches the surfaces of the interlayer insulating films 30r and 30b from the upper surface of the insulating film 43i, is formed. The trench TR extends in the shape of a lattice so as to define the boundaries of the plurality of pixels when viewed in the Z direction (see FIG. 5).

Accordingly, the multilayer interference filter 120r in which the first insulating layers 21r-1, 21r-2, 21r-3, and 21r-4 and the second insulating layers 22r-1, 22r-2, and 22r-3 are alternately laminated a plurality of times is formed above the photoelectric conversion unit 11r. The trench TR forms the side surfaces 120r1 to 120r4 of the multilayer interference filter 120r (see FIG. 4B). Further, the multilayer interference filter 120b in which the first insulating layers 21b-1, 21b-2, 21b-3, and 21b-4 and the second insulating layers 22b-1, 22b-2, and 22b-3 are alternately laminated a plurality of times is formed above the photoelectric conversion unit 11b. The trench TR forms the side surfaces 120b1 to 120b4 of the multilayer interference filter 120b (see FIG. 4B).

Meanwhile, when a wire to connect the reflective unit 170 to the ground line and/or the ground line is formed so as to have a damascene structure, a trench corresponding to the wire and/or a trench corresponding to the ground line may be formed simultaneously with the formation of the trench TR or after the formation of the trench TR.

In a process illustrated in FIG. 7B, a conductive material is embedded in the through holes TH and the trench TR at a time by a CVD method or the like. The conductive material is formed of a material that contains at least one of, for example, Al, Ag, Cu, Ta, W, Mo, and Ti as a main component. The conductive material is embedded in the through holes TH to form the contact plugs 81g, and the same conductive material is also embedded in the trench TR to form the reflective unit 170.

Meanwhile, at this time, a conductive material may be embedded in the trench corresponding to the wire to form a wire that connects the reflective unit 170 to the ground line. Further, a conductive material may be embedded in the trench corresponding to the ground line to form the ground line in the peripheral region of the pixel array PA (see FIG. 3).

In a process illustrated in FIG. 7C, a pixel electrode film 61i, which covers the contact plugs 81g, the reflective unit 170, and the insulating films 43r and 43b, is deposited entirely by a sputtering method or the like. The pixel electrode film 61i is made of, for example, a transparent conductive material, such as ITO or ZnO. Further, portions of the pixel electrode film 61i corresponding to the boundary regions of the pixels are selectively removed by a lithography method and a dry etching method, so that the void VD is formed. When viewed in the Z direction, the air gap structure AG1 including the void VD includes the reflective unit 170 and is formed in a pattern in which a line having a width larger than the width of the reflective unit 170 extends in the shape of a lattice (see a pattern illustrated in FIG. 4B by a dotted line). Accordingly, the pixel electrode films 61g, which are electrically separated from each other for the respective pixels, are formed.

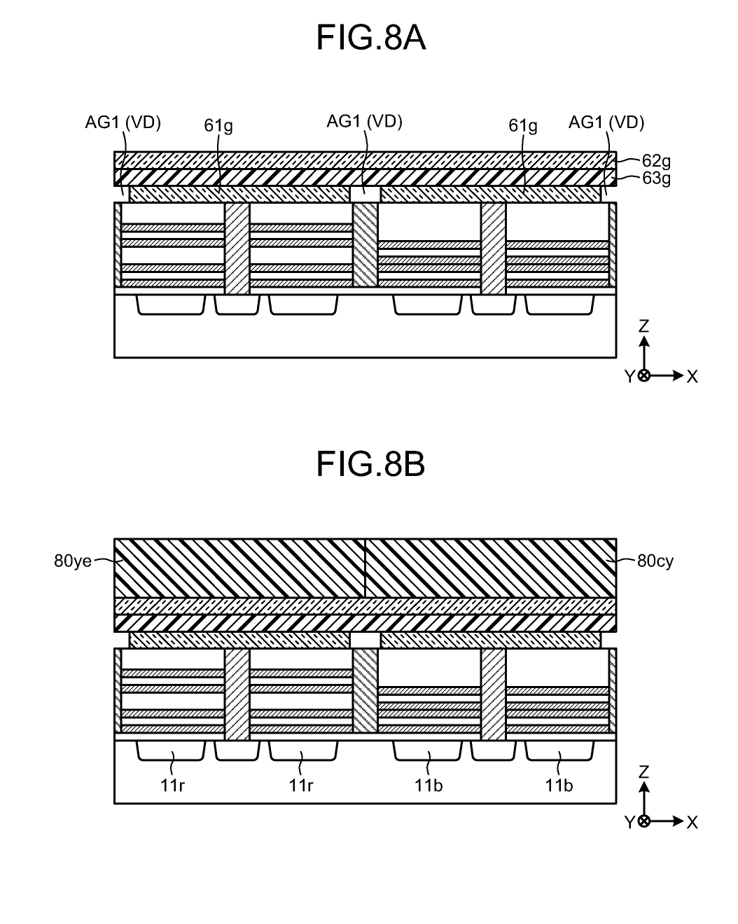

In a process illustrated in FIG. 8A, the photoelectric conversion film 63g, which covers the pixel electrode films 61g and the air gap structure AG1, is formed through deposition by a sputtering method or the like. The photoelectric conversion film 63g is made of, for example, an organic material, such as quinacridone, having a property that absorbs light corresponding to a green wavelength region and transmits light corresponding to other wavelength regions. Further, the common electrode film 62g, which covers the photoelectric conversion film 63g, is formed through deposition by a sputtering method or the like. The common electrode film 62g is made of, for example, a transparent conductive material, such as ITO or ZnO.

In a process illustrated in FIG. 8B, the color filters 80ye and 80cy are formed on the common electrode film 62g. That is, the color filter 80ye is formed in a region of the upper surface of the common electrode film 62g corresponding to the photoelectric conversion unit 11r, and the color filter 80cy is formed in a region of the upper surface of the common electrode film 62g corresponding to the photoelectric conversion unit 11b. For example, the color filter 80ye is made of an organic material containing a yellow pigment, and the color filter 80cy is made of an organic material containing a cyan pigment.

As described above, in the first embodiment, the reflective unit 170 is disposed on the side surfaces 120r1 to 120r4 and 120b1 to 120b4 of the multilayer interference filters 120r and 120b and covers the side surfaces 120r1 to 120r4 and 120b1 to 120b4 of the multilayer interference filters 120r and 120b in the respective pixels P101 and P102 of the solid-state imaging device 105. Accordingly, for example, in the pixel P101, the reflective unit 170 can reflect green light, which has been multiply reflected in the multilayer interference filter 120r and reached the side surfaces 120r1 to 120r4, so that the green light is returned to the multilayer interference filter 120r from the side surfaces 120r1 to 120r4. As a result, it is possible to prevent green light from leaking to the photoelectric conversion film 63g of the adjacent pixel P102, and to efficiently reflect the light, which corresponds to a green wavelength region, by the multilayer interference filter 120r and the reflective unit 170 to guide the light to the photoelectric conversion film 63g of the pixel P101. Accordingly, when the organic photoelectric conversion film is made thin to meet a demand for the reduction of a voltage, it is possible to efficiently guide light to the organic photoelectric conversion film while suppressing the mixing of colors between the pixels. Therefore, it is possible to improve the sensitivity of the organic photoelectric conversion film.

For example, when the thickness of the organic photoelectric conversion film is set to 0.16 μm in a case in which the multilayer interference filters 120r and 120b and the reflective unit 170 are not provided, 68% of green light entering the organic photoelectric conversion film is absorbed and photoelectrically converted by the organic photoelectric conversion film and the rest, that is, 32% of the green light passes through the organic photoelectric conversion film. That is, there is a possibility that the photoelectric conversion efficiency of the organic photoelectric conversion film cannot meet a required level.

In contrast, when the thickness of the organic photoelectric conversion film is set to 0.16 μm in a case in which the multilayer interference filters 120r and 120b and the reflective unit 170 are provided as in the first embodiment, 90% of green light entering and re-entering the organic photoelectric conversion film is absorbed and photoelectrically converted by the organic photoelectric conversion film and the rest, that is, 10% of the green light passes through the organic photoelectric conversion film. That is, according to the first embodiment, even though the thickness of the organic photoelectric conversion film is reduced, that is, set to 0.16 μm in order to meet a demand for the reduction of a voltage, it is possible to improve the photoelectric conversion efficiency of the organic photoelectric conversion film about the green light, which enters and re-enters the organic photoelectric conversion film, up to a level equal to or higher than a required level. Accordingly, it is possible to improve the sensitivity of the organic photoelectric conversion film.

Further, in the first embodiment, the multilayer interference filters 120r and 120b of the respective pixels P101 and P102 of the solid-state imaging device 105 selectively guide second color (red or blue) light of light, which has passed through the photoelectric conversion unit 60g, to the photoelectric conversion units 11r and 11b, and reflect first color (green) light to guide the green light to the photoelectric conversion unit 60g. Accordingly, it is possible to efficiently guide light to the photoelectric conversion film 63g of the photoelectric conversion unit 60g while making each of the pixels P101 and P102 correspond to two colors.

Furthermore, in the first embodiment, the reflective unit 170 is disposed in the respective pixels P101 and P102 of the solid-state imaging device 105 so as to surround the multilayer interference filters 120r and 120b when viewed in the Z direction. Accordingly, it is possible to suppress the mixing of colors between the respective pixels that are adjacent to each other in the respective directions, such as +X direction, +Y direction, −X direction, and −Y direction.

Moreover, in the first embodiment, in the respective pixels P101 and P102 of the solid-state imaging device 105, the reflective unit 170 is configured by embedding the conductive material in the trench TR which forms the side surfaces 120r1 to 120r4 and 120b1 to 120b4 of the multilayer interference filters 120r and 120b. The trench TR is formed so as to surround the multilayer interference filters 120r and 120b when viewed in the Z direction. Accordingly, the reflective unit 170 is configured so as to surround the multilayer interference filters 120r and 120b when viewed in the Z direction. At this time, the same conductive material is embedded in the through holes TH that form the contact plugs 81g and the trench TR at a time. Accordingly, it is possible to form the reflective unit 170 without complicating the manufacturing processes.

Further, in the first embodiment, in the respective pixels P101 and P102 of the solid-state imaging device 105, the reflective unit 170 is connected to the ground potential. Accordingly, it is possible to suppress the influence of the potential of the reflective unit 170 that is applied to the periphery due to capacitive coupling or the like.

Furthermore, in the first embodiment, in the respective pixels P101 and P102 of the solid-state imaging device 105, the reflective unit 170 is cofigured to be electrically insulated from the pixel electrode film 61g. For example, the reflective unit 170 has a pattern that surrounds the pixel electrode film 61g without overlapping the pixel electrode film 61g when viewed in the Z direction. Accordingly, it is possible to suppress the influence of the potential of the reflective unit 170 on the signal charges that are collected by the pixel electrode film 61g.

Moreover, in the first embodiment, in the respective pixels P101 and P102 of the solid-state imaging device 105, the color filters 80ye and 80cy are disposed on one side of the photoelectric conversion film 63g opposite to the photoelectric conversion units 11r and 11b. Accordingly, since unnecessary light, which enters from the below, can be absorbed by the color filters 80ye and 80cy, it is possible to suppress the reflection of the unnecessary light toward the object from the solid-state imaging device 105.

Further, in the first embodiment, in the solid-state imaging device 105, the reflective unit 170 is disposed in the boundary regions of the two adjacent pixels P101 and P102 and is shared between the two adjacent pixels P101 and P102. Accordingly, the reflective unit 170 for the plurality of pixels extends in the shape of a lattice so as to define the boundaries of the pixels when viewed in the Z direction. Therefore, it is possible to ensure the light receiving area of each pixel and to efficiently suppress the mixing of colors between the pixels. Furthermore, when the plurality of pixels are considered as a whole, it is possible to improve the stiffness of the multilayer interference filters 120r and 120b of the plurality of pixels. Accordingly, it is possible to improve the multilayer interference filters 120r and 120b of the plurality of pixels in terms of strength.

Meanwhile, a case in which the photoelectric conversion film 63g is constructed of an organic film has been exemplified in the first embodiment, but the photoelectric conversion film 63g may be constructed of an inorganic film. For example, the photoelectric conversion film 63g may be made of a material containing a material, which is selected from a group consisting of, for example, silicon, cadmium sulfide, cadmium selenide, lead sulfide, and lead selenide, as a main component. Alternatively, the photoelectric conversion film 63g may be made of a material containing a material, which has a band gap smaller than the band gap of silicon, such as Ge, SiGe, amorphous Si, amorphous Ge, SiGe, as a main component.

### Second Embodiment

Next, a solid-state imaging device according to a second embodiment will be described. Portions different from the first embodiment will be mainly described below.

In the first embodiment, the reflective unit 170 has been made of the conductive material that is embedded in the trench TR. However, in the second embodiment, a reflective unit 270 is formed of an air gap structure AG2 of which a trench TR is filled with gas.

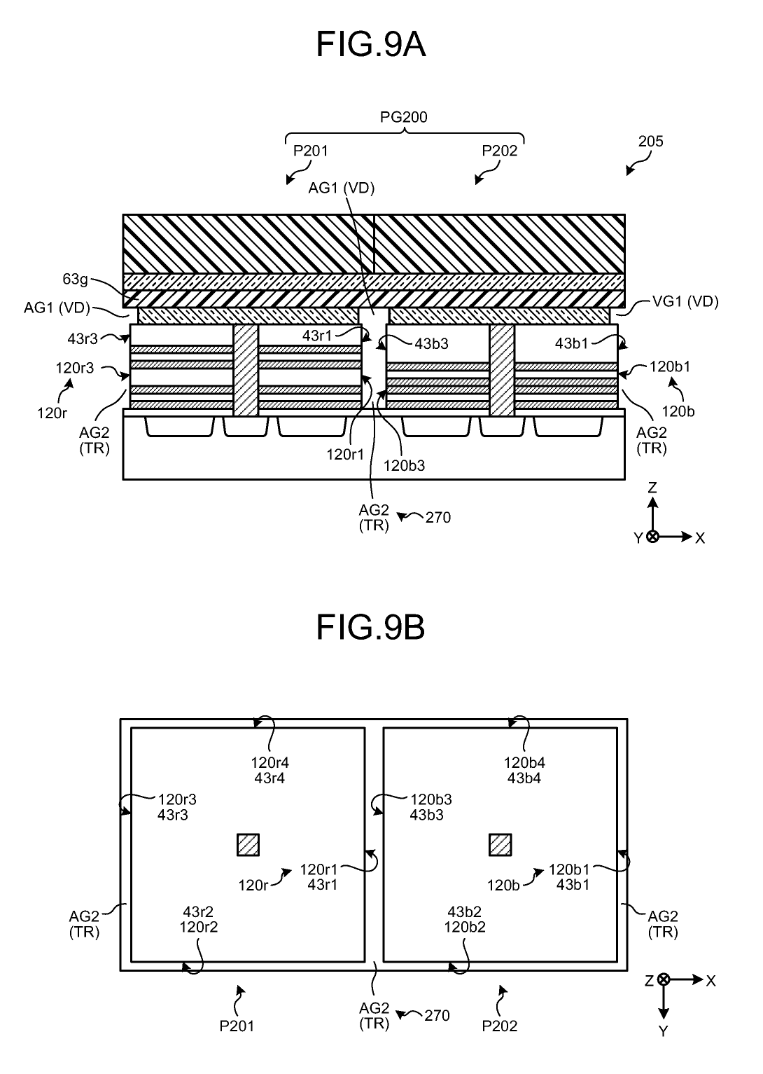

Specifically, in a solid-state imaging device 205, a unit pixel group PG200 is two-dimensionally arrayed in the pixel array PA (see FIG. 3) instead of the unit pixel group PG100 (see FIGS. 4A and 4B) as illustrated in FIGS. 9A and 9B. FIG. 9A is a diagram illustrating the cross-sectional structure of the solid-state imaging device 205 that is cut perpendicular to the Y direction, and FIG. 9B is a diagram illustrating the planar structure of the solid-state imaging device 205 that is cut perpendicular to the Z direction at Z positions corresponding to multilayer interference filters 120r and 120b.

The unit pixel group PG200 includes two pixels P201 and P202 instead of the two pixels P101 and P102 (see FIGS. 4A and 4B). The pixel P201 corresponds to green (G) and red (R), and the pixel P202 corresponds to green (G) and blue (B).

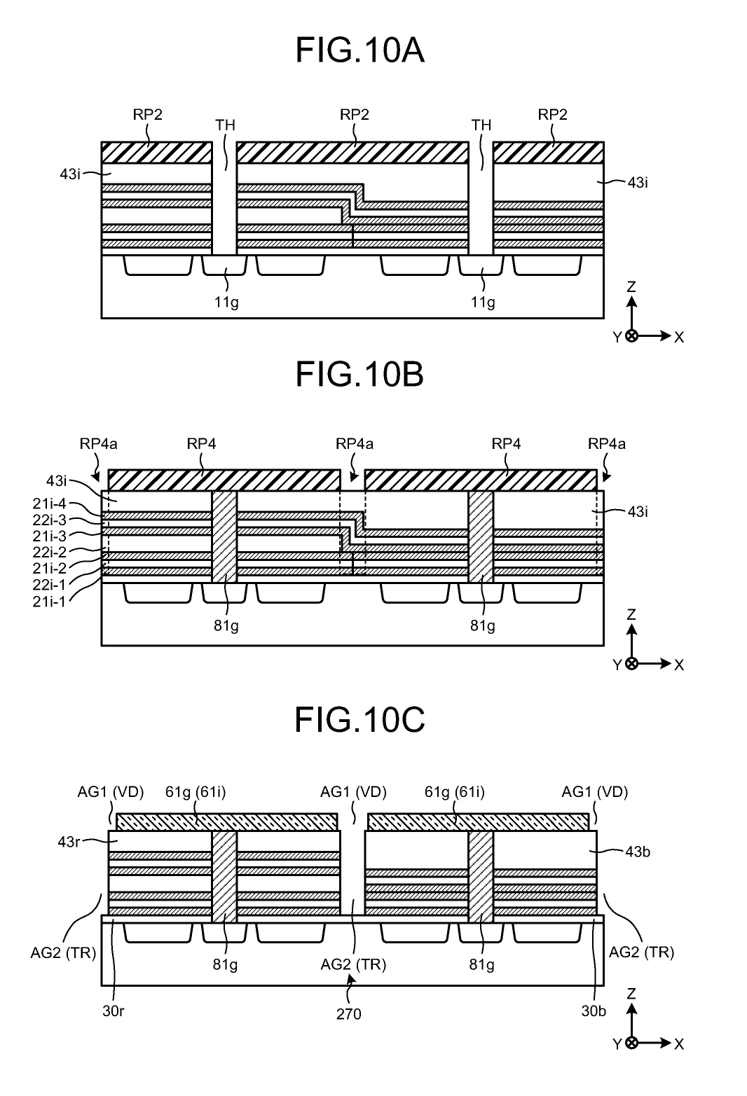

The pixel P201 includes a reflective unit 270 instead of the reflective unit 170 (see FIGS. 4A and 4B). The reflective unit 270 includes the air gap structure AG2. The air gap structure AG2 is configured by filling a trench TR (FIG. 10C) with air or predetermined gas (for example, nitrogen gas, inert gas, or the like). The trench TR forms side surfaces 120r1 to 120r4 of the multilayer interference filter 120r and side surfaces 43r1 to 43r4 of an insulating film 43r. The air gap structure AG2 including the trench TR is disposed so as to surround the multilayer interference filters 120r and 120b when viewed in the Z direction.

For example, when the trench TR is filled with air, the refractive index of the air gap structure AG2 (trench TR) is approximately 1. When a first insulating layer of the multilayer interference filter 120r is made of titanium oxide (TiO₂, having a refractive index of 2.5) and a second insulating layer thereof is made of silicon oxide (SiO₂, having a refractive index of 1.45), the refractive index of the air gap structure AG2 is lower than any of the refractive index of the first insulating layer and the refractive index of the second insulating layer. Further, any of a difference between the refractive index of the air gap structure AG2 and the refractive index of the first insulating layer and a difference between the refractive index of the air gap structure AG2 and the refractive index of the second insulating layer are relatively large. Accordingly, light, which travels toward the air gap structure AG2 from the inside of the multilayer interference filter 120r, is likely to be totally reflected by an interface between the multilayer interference filter 120r and the air gap structure AG2. In other words, interfaces between the multilayer interference filter 120r and the air gap structure AG2, that is, the side surfaces 120r1 to 120r4 of the multilayer interference filter 120r can function as reflective surfaces.

Accordingly, the reflective unit 270 including the air gap structure AG2 can reflect green light, which has been multiply reflected in the multilayer interference filter 120r, so that the green light is returned to the multilayer interference filter 120r from the side surfaces 120r1 to 120r4. As a result, it is possible to prevent green light from leaking to the adjacent pixel P202, and to efficiently reflect the light, which corresponds to a green wavelength region, by the multilayer interference filter 120r and the reflective unit 270 to guide the light to a photoelectric conversion film 63g of the pixel P201. Further, the reflective unit 270 can reflect light, which has been reflected by the multilayer interference filter 120r and reached the side surfaces 43r1 to 43r4 of the insulating film 43r, at the side surfaces 43r1 to 43r4 of the insulating film 43r to guide the light to the photoelectric conversion film 63g of the pixel P201.

Meanwhile, the trench TR of the air gap structure AG2 communicates with a void VD of an air gap structure AG1. The width of the trench TR of the air gap structure AG2 may be smaller than the width of the void VD of the air gap structure AG1, and may be equal to the width of the void VD of the air gap structure AG1.

Likewise, the pixel P202 includes a reflective unit 270 instead of the reflective unit 170 (see FIGS. 4A and 4B). The reflective unit 270 includes an air gap structure AG2. The air gap structure AG2 is configured by filling a trench TR (see FIG. 10C) with air or predetermined gas (for example, nitrogen gas, inert gas, or the like). The trench TR forms side surfaces 120b1 to 120b4 of the multilayer interference filter 120b and side surfaces 43b1 to 43b4 of an insulating film 43b. That is, even in the pixel P202, interfaces between the multilayer interference filter 120b and the air gap structure AG2 (the side surfaces 120b1 to 120b4 of the multilayer interference filter 120b) function as reflective surfaces.

Accordingly, the reflective unit 270 including the air gap structure AG2 can reflect green light, which has been multiply reflected in the multilayer interference filter 120b, so that the green light is returned to the multilayer interference filter 120b from the side surfaces 120b1 to 120b4. As a result, it is possible to prevent green light from leaking to the adjacent pixel P201, and to efficiently reflect the light, which corresponds to a green wavelength region, by the multilayer interference filter 120b and the reflective unit 270 to guide the light to the photoelectric conversion film 63g of the pixel P202. Further, the reflective unit 270 can reflect light, which has been reflected by the multilayer interference filter 120b and reached the side surfaces 43b1 to 43b4 of the insulating film 43b, at the side surfaces 43b1 to 43b4 of the insulating film 43b to guide the light to the photoelectric conversion film 63g of the pixel P202.

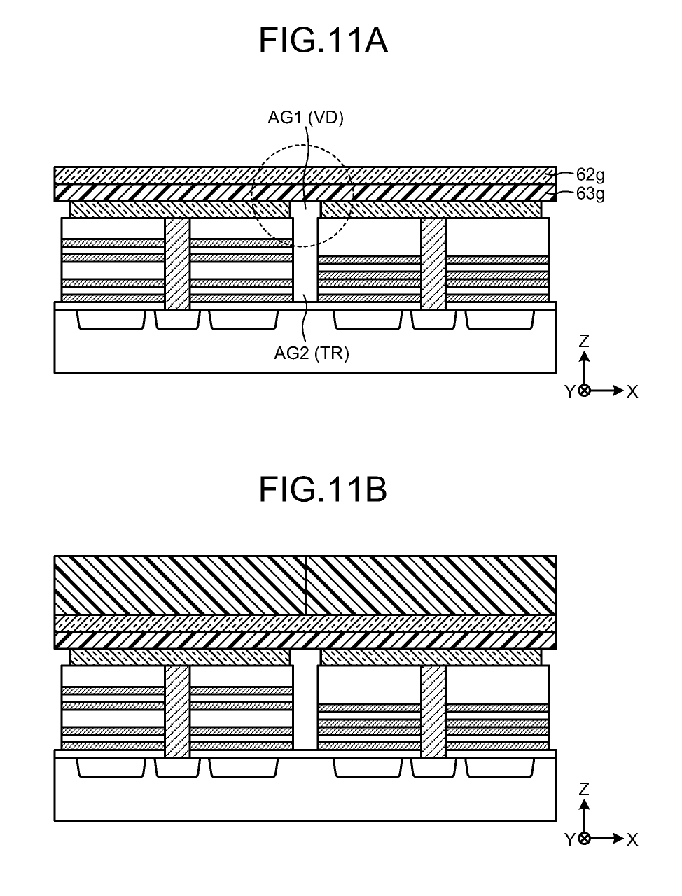

Furthermore, a method of manufacturing the solid-state imaging device 205 is different from that according to the first embodiment in terms of the following as illustrated in FIGS. 10A to 11B. FIGS. 10A to 11B are cross-sectional views illustrating processes of the method of manufacturing the solid-state imaging device 205.

In a process illustrated in FIG. 10A, a resist pattern RP2 is formed on an insulating film 43i as in the process illustrated in FIG. 6D. Further, while the resist pattern RP2 is used as a mask, etching is performed until the surfaces of charge holding units 11g are exposed to the outside. Accordingly, through holes TH, which pass through the respective layers to the surfaces of the charge holding units 11g from the upper surface of the insulating film 43i, are formed.

In a process illustrated in FIG. 10B, a conductive material is embedded in the through holes TH by a CVD method or the like. The conductive material is formed of a material that contains at least one of, for example, Al, Ag, Cu, Ta, W, Mo, and Ti as a main component. The conductive material is embedded in the through holes TH to form contact plugs 81g.

Further, a resist pattern RP4 is formed on the insulating film 43i. The resist pattern RP4 includes an opening RP4a in a region (see FIG. 9B) where the reflective unit 270 is to be disposed. Furthermore, the insulating film 43i, the first insulating layer 21-4, the second insulating layer 22-3, the first insulating layer 21-3, the second insulating layer 22-2, the first insulating layer 21-2, the second insulating layer 22-1, and the first insulating layer 21-1 are etched by a dry etching method as illustrated by a dotted line while the resist pattern RP4 is used as a mask. Accordingly, the trench TR (see FIG. 10C), which has a depth reaching the surfaces of the interlayer insulating films 30r and 30b from the upper surface of the insulating film 43i, is formed.

In a process illustrated in FIG. 10C, a pixel electrode film 61i, which covers the contact plugs 81g, the reflective unit 270, and the insulating films 43r and 43b, is deposited entirely by a sputtering method or the like. At this time, a sputtering condition is adjusted to a condition of a poor coverage so that the pixel electrode film 61i remains near the upper portion of the trench TR and does not enter the bottom portion of the trench TR. Further, portions of the pixel electrode film 61i corresponding to the boundary regions of the pixels are selectively removed by a lithography method and a dry etching method, so that the void VD is formed. At this time, the pixel electrode film 61i, which remains near the upper portion of the trench TR, is also removed. The pixel electrode films 61g, which are electrically separated from each other for the respective pixels by the air gap structure AG1 including the void VD, are formed.

In a process illustrated in FIG. 11A, the photoelectric conversion film 63g, which covers the pixel electrode films 61g and the air gap structure AG1, is formed by a coating method. That is, the upper surfaces of pixel electrode films 61g and the air gap structure AG1 are coated with an organic material, which has high viscosity, as a material of the photoelectric conversion film 63g. Accordingly, it is possible to prevent the material (organic material) of the photoelectric conversion film 63g from entering the void VD of the air gap structure AG1 and the trench TR of the air gap structure AG2 as illustrated so as to be surrounded by a dotted line. Further, a common electrode film 62g, which covers the photoelectric conversion film 63g, is formed through deposition by a sputtering method or the like. The common electrode film 62g is made of, for example, a transparent conductive material, such as ITO or ZnO.

Similar process to the process illustrated in FIG. 8B is performed in a process illustrated in FIG. 11B.

As described above, in the second embodiment, in the respective pixels P201 and P202 of the solid-state imaging device 205, the reflective unit 270 is configured by the air gap structure AG2 where the trench TR forming the side surfaces 120r1 to 124r4 and 120b1 to 120b4 of the multilayer interference filters 120r and 120b is filled with gas. The air gap structure AG2 is disposed so as to surround the multilayer interference filters 120r and 120b when viewed in the Z direction. Accordingly, interfaces between the multilayer interference filters 120r and 120b and the air gap structure AG2 can function as reflective surfaces. For example, the reflective unit 270, which includes the air gap structure AG2, of the pixel P201 can reflect green light, which has been multiply reflected in the multilayer interference filter 120r, so that the green light is returned to the multilayer interference filter 120r from the side surfaces 120r1 to 120r4. As a result, it is possible to prevent green light from leaking to the adjacent pixel P202, and to efficiently reflect the light, which corresponds to a green wavelength region, by the multilayer interference filter 120r and the reflective unit 270 to guide the light to the photoelectric conversion film 63g of the pixel P201. Further, the reflective unit 270 can reflect light, which has been reflected by the multilayer interference filter 120r and reached the side surfaces 43r1 to 43r4 of the insulating film 43r, at the side surfaces 43r1 to 43r4 of the insulating film 43r to guide the light to the photoelectric conversion film 63g of the pixel P201.

Meanwhile, in the processes illustrated in FIGS. 10B and 10C, the void VD is formed after the trench TR is formed. However, the void VD and the trench TR may be continuously formed. For example, after a conductive material is embedded in the through holes TH, the pixel electrode film 61i is entirely deposited without the formation of the resist pattern RP4. Then, the resist pattern RP4 is formed. Furthermore, the pixel electrode film 61i, the insulating film 43i, the first insulating layer 21-4, the second insulating layer 22-3, the first insulating layer 21-3, the second insulating layer 22-2, the first insulating layer 21-2, the second insulating layer 22-1, and the first insulating layer 21-1 are etched by a dry etching method while the resist pattern RP4 is used as a mask. Accordingly, it is possible to continuously form the void VD and the trench TR while simplifying the manufacturing processes.

At this time, the pattern of the trench TR of the air gap structure AG2 corresponds to the pattern of the void VD of the air gap structure AG1. That is, the pixel electrode film 63g has a pattern corresponding to (for example, matching) the pattern of the reflective unit 270 when viewed in the Z direction.

### Third Embodiment

Next, a solid-state imaging device according to a third embodiment will be described. Portions different from the first embodiment will be mainly described below.

In the first embodiment, the reflective unit 170 has been made of the conductive material that is embedded in the trench TR. However, in the third embodiment, a reflective unit 370 is made of an insulating material that is embedded in a trench TR.

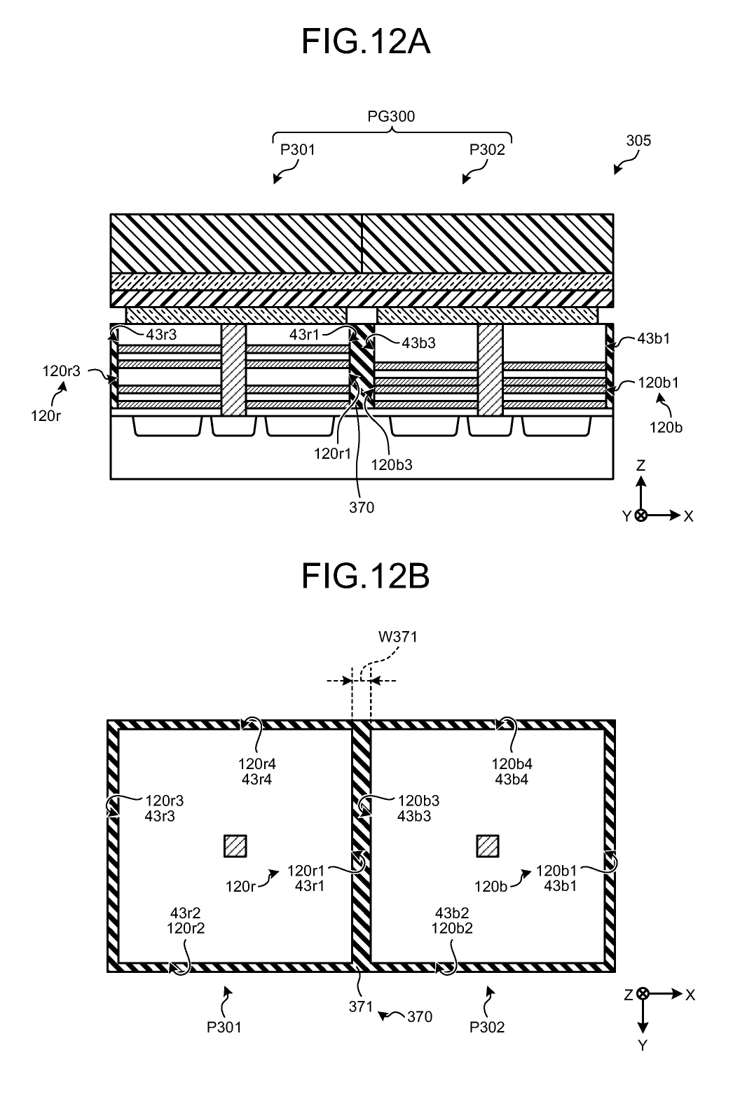

Specifically, in a solid-state imaging device 305, a unit pixel group PG300 is two-dimensionally arrayed in the pixel array PA (see FIG. 3) instead of the unit pixel group PG100 (see FIGS. 4A and 4B) as illustrated in FIGS. 12A and 12B. FIG. 12A is a diagram illustrating the cross-sectional structure of the solid-state imaging device 305 that is cut perpendicular to the Y direction, and FIG. 12B is a diagram illustrating the planar structure of the solid-state imaging device 305 that is cut perpendicular to the Z direction at Z positions corresponding to multilayer interference filters 120r and 120b.

The unit pixel group PG300 includes two pixels P301 and P302 instead of the two pixels P101 and P102 (see FIGS. 4A and 4B). The pixel P301 corresponds to green (G) and red (R), and the pixel P302 corresponds to green (G) and blue (B).

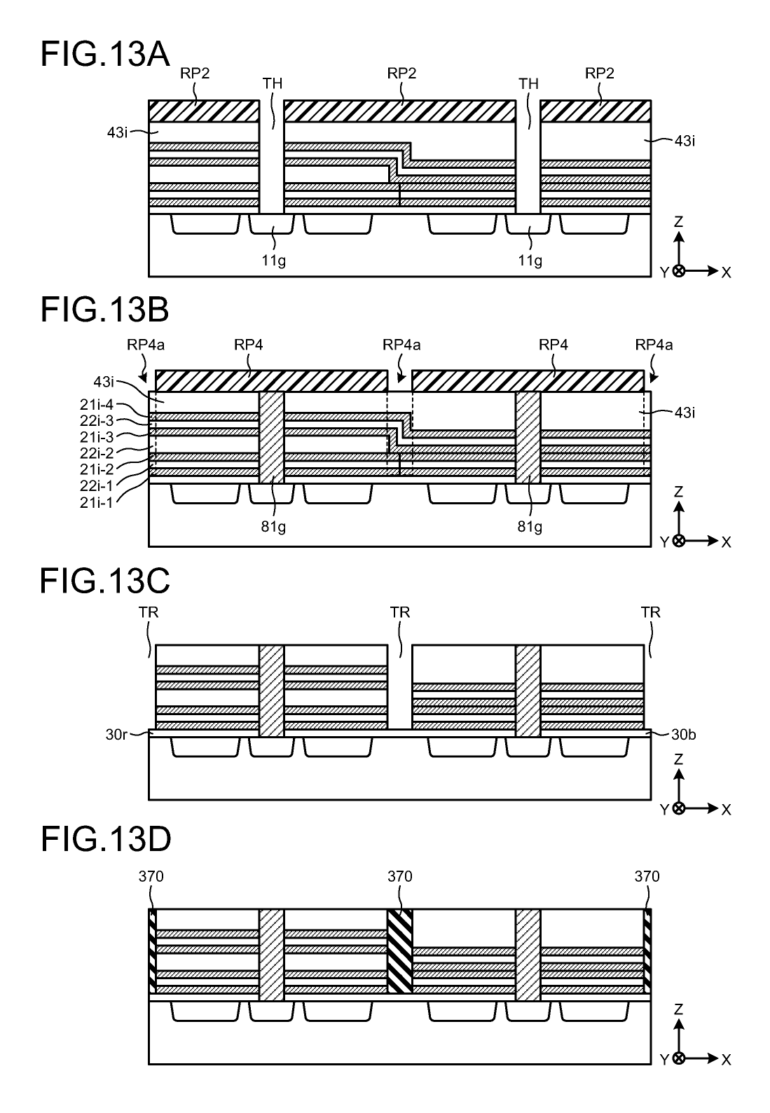

The pixel P301 includes a reflective unit 370 instead of the reflective unit 170 (see FIGS. 4A and 4B). The reflective unit 370 is configured by embedding an insulating material in a trench TR (see FIG. 13C) which forms side surfaces 120r1 to 120r4 of the multilayer interference filter 120r.

When first and second insulating layers of the multilayer interference filter 120r are alternately laminated, a material having a refractive index, which is different from the refractive index of the first insulating layer and the refractive index of the second insulating layer, is used as the insulating material. For example, when the first insulating layer of the multilayer interference filter 120r is made of titanium oxide (TiO₂, having a refractive index of 2.5) and the second insulating layer thereof is made of silicon oxide (SiO₂, having a refractive index of 1.45), the insulating material includes a material that contains at least one of silicon nitride (Si₃N₄, having a refractive index of 2.0), aluminum oxide (Al₂O₃, having a refractive index of 1.63), and hafnium oxide (HfO₂, having a refractive index of 1.95) as a main component.

Further, the optical width of the reflective unit 370 in a direction perpendicular to the side surfaces 120r1 to 120r4, which are covered with the reflective unit 370, is significantly larger than a quarter of the center wavelength (for example, 550 nm) of the multilayer interference filter 120r. For example, when the refractive index of the reflective unit 370 is denoted by n371 and the width of a portion 371, which covers the side surface 120r1 of the multilayer interference filter 120r corresponding to an X side, in the X direction is denoted by W371, “n371×W371 >>550×¼ (nm)” is satisfied.

In other words, an insulating material having a refractive index, which is different from the refractive index of the first insulating layer and the refractive index of the second insulating layer, is used as the material of the reflective unit 370 and the optical width of the reflective unit 370 in a direction perpendicular to the side surfaces, which are covered with the reflective unit 370, is significantly larger than a quarter of the center wavelength of the multilayer interference filter 120r. Accordingly, interfaces between the multilayer interference filter 120r and the reflective unit 370, that is, the side surfaces 120r1 to 120r4 of the multilayer interference filter 120r can function as reflective surfaces.

Therefore, the reflective unit 370 can reflect green light, which has been multiply reflected in the multilayer interference filter 120r, so that the green light is returned to the multilayer interference filter 120r from the side surfaces 120r1 to 120r4. As a result, it is possible to prevent green light from leaking to the adjacent pixel P302, and to efficiently reflect the light, which corresponds to a green wavelength region, by the multilayer interference filter 120r and the reflective unit 370 to guide the light to the photoelectric conversion film 63g of the pixel P301. Further, the reflective unit 370 can reflect light, which has been reflected by the multilayer interference filter 120r and reached side surfaces 43r1 to 43r4 of an insulating film 43r, at the side surfaces 43r1 to 43r4 of the insulating film 43r to guide the light to the photoelectric conversion film 63g of the pixel P301.

Meanwhile, the width of the reflective unit 370 may be smaller than the width of the void VD of the air gap structure AG1 and may be substantially equal to the width of the void VD of the air gap structure AG1 in a direction that is perpendicular to the side surfaces covered with the reflective unit 370.

Likewise, the pixel P302 includes the reflective unit 370 instead of the reflective unit 170 (see FIGS. 4A and 4B). The reflective unit 370 is configured by embedding an insulating material which has a refractive index different from the refractive indexes of the first and second insulating layers of the multilayer interference filter 120b, in a trench TR (see FIG. 13C) which forms side surfaces 120b1 to 120b4 of the multilayer interference filter 120b. That is, even in the pixel P302, interfaces between the multilayer interference filter 120b and the reflective unit 370 (the side surfaces 120b1 to 120b4 of the multilayer interference filter 120b) function as reflective surfaces.

Accordingly, the reflective unit 370 can reflect green light, which has been multiply reflected in the multilayer interference filter 120b, so that the green light is returned to the multilayer interference filter 120b from the side surfaces 120b1 to 120b4. As a result, it is possible to prevent green light from leaking to the adjacent pixel P301, and to efficiently reflect the light, which corresponds to a green wavelength region, by the multilayer interference filter 120b and the reflective unit 370 to guide the light to the photoelectric conversion film 63g of the pixel P302. Further, the reflective unit 370 can reflect light, which has been reflected by the multilayer interference filter 120b and reached side surfaces 43b1 to 43b4 of an insulating film 43b, at the side surfaces 43b1 to 43b4 of the insulating film 43b to guide the light to the photoelectric conversion film 63g of the pixel P302.

Furthermore, a method of manufacturing the solid-state imaging device 305 is different from that according to the first embodiment in terms of the following as illustrated in FIGS. 13A to 13D. FIGS. 13A to 13D are cross-sectional views illustrating processes of the method of manufacturing the solid-state imaging device 305.

In a process illustrated in FIG. 13A, a resist pattern RP2 is formed on an insulating film 43i as in the process illustrated in FIG. 6D. Further, while the resist pattern RP2 is used as a mask, etching is performed until the surfaces of charge holding units 11g are exposed to the outside. Accordingly, through holes TH, which pass through the respective layers to the surfaces of the charge holding units 11g from the upper surface of the insulating film 43i, are formed.

In a process illustrated in FIG. 13B, a conductive material is embedded in the through holes TH by a CVD method or the like. The conductive material is formed of a material that contains at least one of, for example, Al, Ag, Cu, Ta, W, Mo, and Ti as a main component. The conductive material is embedded in the through holes TH to form contact plugs 81g. Furthermore, a resist pattern RP4 is formed on the insulating film 43i. The resist pattern RP4 includes an opening RP4a in a region (see FIG. 9B) where the reflective unit 370 is to be disposed.

In a process illustrated in FIG. 13C, the insulating film 43i, the first insulating layer 21-4, the second insulating layer 22-3, the first insulating layer 21-3, the second insulating layer 22-2, the first insulating layer 21-2, the second insulating layer 22-1, and the first insulating layer 21-1 are etched by a dry etching method as illustrated by a dotted line while the resist pattern RP4 (see FIG. 13B) is used as a mask. Accordingly, the trench TR, which has a depth reaching the surfaces of the interlayer insulating films 30r and 30b from the upper surface of the insulating film 43i, is formed. After that, the resist pattern RP4 is removed.

In a process illustrated in FIG. 13D, an insulating material is embedded in the trench TR by an ALD (Atomic Layer Deposition) method, an HDP (High Density Plasma) method, or the like. The insulating material is formed of, for example, a material that contains at least one of silicon nitride (Si₃N₄), aluminum oxide (Al₂O₃), and hafnium oxide (HfO₂) as a main component. A conductive material is embedded in the trench TR to form the reflective unit 370.

After that, similar processes to the processes, which have been performed in FIG. 7C or later, are performed.

As described above, in the third embodiment, in the respective pixels P301 and P302 of the solid-state imaging device 305, the reflective unit 370 is configured by embedding the insulating material in the trench TR which forms the side surfaces of the multilayer interference filters 120r and 120b. The reflective unit 370 is disposed so as to surround the multilayer interference filters 120r and 120b when viewed in the Z direction. At this time, an insulating material having a refractive index, which is different from the refractive index of the first insulating layer and the refractive index of the second insulating layer, is used as the material of the reflective unit 370 and the width of the reflective unit 370 in the direction perpendicular to the side surfaces, which are covered with the reflective unit 370, is significantly larger than a quarter of the center wavelength of the multilayer interference filter 120b. Accordingly, interfaces between the multilayer interference filters 120r and 120b and the reflective unit 370 can function as reflective surfaces. For example, in the pixel P301, the reflective unit 370 can reflect green light, which has been multiply reflected in the multilayer interference filter 120r, so that the green light is returned to the multilayer interference filter 120r from the side surfaces 120r1 to 120r4. As a result, it is possible to prevent green light from leaking to the adjacent pixel P302, and to efficiently reflect the light, which corresponds to a green wavelength region, by the multilayer interference filter 120r and the reflective unit 370 to guide the light to the photoelectric conversion film 63g of the pixel P301. Further, the reflective unit 370 can reflect light, which has been reflected by the multilayer interference filter 120r and reached the side surfaces 43r1 to 43r4 of the insulating film 43r, at the side surfaces 43r1 to 43r4 of the insulating film 43r to guide the light to the photoelectric conversion film 63g of the pixel P301.

Furthermore, in the third embodiment, in the solid-state imaging device 305, the reflective unit 370 is disposed in the boundary regions of the two adjacent pixels P301 and P302 and is shared between the two adjacent pixels P301 and P302. Accordingly, the reflective unit 370 for the plurality of pixels extends in the shape of a lattice so as to define the boundaries of the pixels when viewed in the Z direction. At this time, since the reflective unit 370 is made of an insulating material, it is not necessary to consider the influence of the potential of the reflective unit 370 on the surroundings and it is possible to ensure the light receiving area of each pixel and to efficiently suppress the mixing of colors between the pixels. Further, when the plurality of pixels are considered as a whole, it is possible to improve the stiffness of the multilayer interference filters 120r and 120b of the plurality of pixels. Accordingly, it is possible to improve the multilayer interference filters 120r and 120b of the plurality of pixels in terms of strength.

### Fourth Embodiment

Next, a solid-state imaging device according to a fourth embodiment will be described. Portions different from the first embodiment will be mainly described below.

Each pixel has been configured to correspond to two colors in the first embodiment, but each pixel is configured to correspond to three colors in a fourth embodiment.

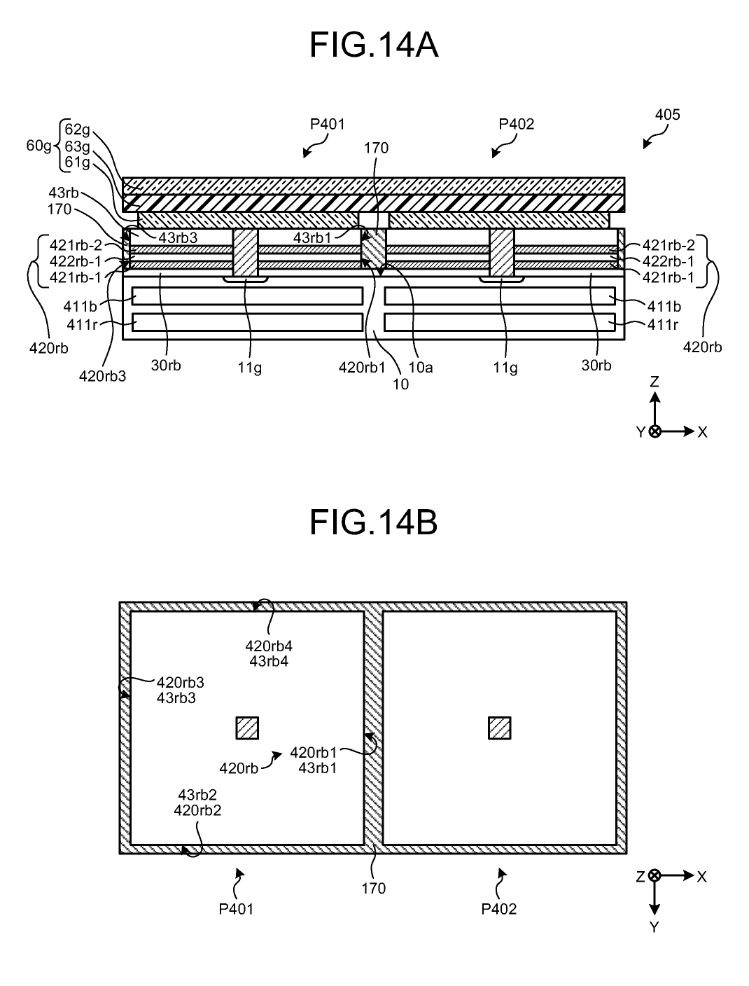

Specifically, a solid-state imaging device 405 is formed as illustrated in FIGS. 14A and 14B. FIG. 14A is a diagram illustrating the cross-sectional structure of the solid-state imaging device 405 that is cut perpendicular to the Y direction, and FIG. 14B is a diagram illustrating the planar structure of the solid-state imaging device 405 that is cut perpendicular to the Z direction at Z positions corresponding to multilayer interference filter 420rb. Portions different from the basic mode will be mainly described below.

In the solid-state imaging device 405, a plurality of pixels including pixels P401 and P402 are two-dimensionally arrayed in the pixel array PA (see FIG. 3). Any of the pixels P401 and P402 correspond to green (G), red (R), and blue (B). Meanwhile, since the structure of the pixel P402 is similar to the structure of the pixel P401, the structure of the pixel P401 will be mainly described.

The pixel P401 does not include color filters 80ye and 80cy, and includes a multilayer interference filter 420rb, a photoelectric conversion unit (second photoelectric conversion unit) 411b, and a photoelectric conversion unit (third photoelectric conversion unit) 411r instead of the multilayer interference filters 120r and 120b and the photoelectric conversion units 11r and 11b (see FIGS. 4A and 4B).

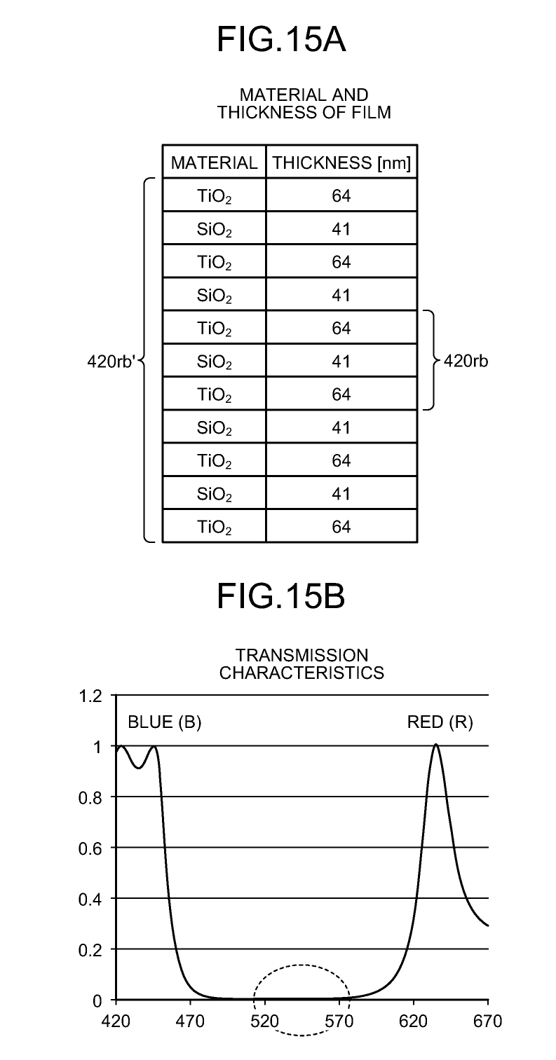

When green (G) light is photoelectrically converted by a photoelectric conversion unit 60g, the multilayer interference filter 420rb selectively guides red (R) light and blue (B) light of light, which has passed through a photoelectric conversion unit 60g, to the photoelectric conversion unit 411b and the photoelectric conversion unit 411r. Filter characteristics of the multilayer interference filter 420rbhave a peak of spectral transmittance in each of a red (R) wavelength band and a blue (B) wavelength band as illustrated in FIG. 15B. FIG. 15B is a diagram illustrating the transmission characteristics (filter characteristics) of the multilayer interference filter 420rb. As illustrated in FIG. 15B so as to be surrounded by a dotted line, the multilayer interference filter 420rb can reflect light that corresponds to a green (G) wavelength region.

When first and second insulating layers of the multilayer interference filter 420rb are alternately laminated and the refractive index of the first insulating layer is higher than the refractive index of the second insulating layer as illustrated in FIG. 15A, it is possible to achieve these transmission characteristics (filter characteristics) by setting the optical thickness of the first insulating layer to a thickness that is larger than a quarter of a center wavelength and setting the optical thickness of the second insulating layer to a thickness that is smaller than a quarter of the center wavelength. FIG. 15A is a diagram illustrating the structure of the multilayer interference filter 420rb.

When the first insulating layer is made of titanium oxide (TiO₂, having a refractive index of 2.5) and the second insulating layer is made of silicon oxide (SiO₂, having a refractive index of 1.45), for example, 64 (nm) is selected as the physical thickness of the first insulating layer and 41 (nm) is selected as the physical thickness of the second insulating layer. If the center wavelength of the multilayer interference filter 420rb is set to 550 nm (λ) at this time, the optical thickness of the first insulating layer is 2.5×64(=160≈λ/3.5>λ/4) and the optical thickness of the second insulating layer is 1.45×41(=59.45≈λ/9.3<λ/4).

Meanwhile, the transmission characteristics (filter characteristics) of FIG. 15B are the results of a simulation that is performed for a multilayer interference filter 420rb′ including six first insulating layers (TiO₂ layers) and five second insulating layers (SiO₂ layers). However, it is confirmed that similar transmission characteristics (filter characteristics) are also obtained from the multilayer interference filter 420rb including two first insulating layers and one second insulating layer.

Specifically, first insulating layers 421rb-1 and 421rb-2 and a second insulating layer 422rb-1 are alternately laminated in the multilayer interference filter 420rb as illustrated in FIG. 14A. The refractive index of each of the first insulating layers 421rb-1 and 421rb-2 is higher than the refractive index of the second insulating layer 422rb-1. The first insulating layers 421rb-1 and 421rb-2 are made of, for example, titanium oxide (TiO₂, having a refractive index of 2.5). The second insulating layer 422rb-1 is made of, for example, silicon oxide (SiO₂, having a refractive index of 1.45).

The respective first insulating layers 421rb-1 and 421rb-2 have similar thickness. The optical thickness of each of the first insulating layers 421rb-1 and 421rb-2 is larger than a quarter of the center wavelength of the multilayer interference filter 420rb. The optical thickness of the second insulating layer 422rb-1 is smaller than a quarter of the center wavelength of the multilayer interference filter 420rb.

The photoelectric conversion unit 411b is disposed in a semiconductor substrate 10. The photoelectric conversion unit 411b is disposed in the semiconductor substrate 10 at a position that is deeper than the position of a charge holding unit 11g. The photoelectric conversion unit 411b is made of a semiconductor (for example, silicon) that contains a second conductive type (for example, N type) impurity with a concentration higher than the concentration of a first conductive type impurity of a well region 13. The photoelectric conversion unit 411b corresponds to blue (B), and is disposed at a depth, which corresponds to an absorption length (0.14 μm) of blue (B), from a surface 10a of the semiconductor substrate 10 (see FIG. 21). Accordingly, the photoelectric conversion unit 411b can photoelectrically convert blue (B) light of light that has passed through the multilayer interference filter 420rb and entered the semiconductor substrate 10. Meanwhile, red (R) light of the light, which has passed through the multilayer interference filter 420rb and entered the semiconductor substrate 10, passes through the photoelectric conversion unit 411b and enters the photoelectric conversion unit 411r.

The photoelectric conversion unit 411r is disposed in the semiconductor substrate 10. The photoelectric conversion unit 411r is made of a semiconductor (for example, silicon) that contains the second conductive type (for example, N type) impurity with a concentration higher than the concentration of the first conductive type impurity of the well region 13. The photoelectric conversion unit 411r corresponds to red (R), and is disposed at a depth, which corresponds to an absorption length (0.50 μm) of red (R), from the surface 10a of the semiconductor substrate 10 (see FIG. 21). That is, the photoelectric conversion unit 411r is disposed in the semiconductor substrate 10 at a position that is deeper than the position of the photoelectric conversion unit 411b. Accordingly, the photoelectric conversion unit 411r can photoelectrically convert red (R) light of light that has passed through the multilayer interference filter 420rb and entered the semiconductor substrate 10.

Meanwhile, a reflective unit 170 is disposed on side surfaces 420rb1, 420rb2, 420rb3, and 420rb4 of the multilayer interference filter 420rb. The reflective unit 170 covers the side surfaces 420rb1 to 420rb4 of the multilayer interference filter 420rb. The reflective unit 170 is disposed so as to surround the multilayer interference filter 420rb when viewed in the Z direction. Accordingly, the reflective unit 170 can reflect green light, which has been multiply reflected in the multilayer interference filter 420rb, so that the green light is returned to the multilayer interference filter 420rb from the side surfaces 420rb1 to 420rb4. As a result, it is possible to prevent green light from leaking to the adjacent pixel P402, and to efficiently reflect the light, which corresponds to a green wavelength region, by the multilayer interference filter 420rb and the reflective unit 170 to guide the light to the photoelectric conversion film 63g of the pixel P401.

The reflective unit 170 is disposed on side surfaces 43rb1 to 43rb4 of an insulating film 43rb. The reflective unit 170 covers the side surfaces 43rb1 to 43rb4 of the insulating film 43rb. The reflective unit 170 is disposed so as to surround the insulating film 43rb when viewed in the Z direction. Accordingly, the reflective unit 170 can reflect light, which has been reflected by the multilayer interference filter 420rb and reached the side surfaces 43rb1 to 43rb4 of the insulating film 43rb, at the side surfaces 43rb1 to 43rb4 of the insulating film 43rb to guide the light to the photoelectric conversion film 63g of the pixel P401.

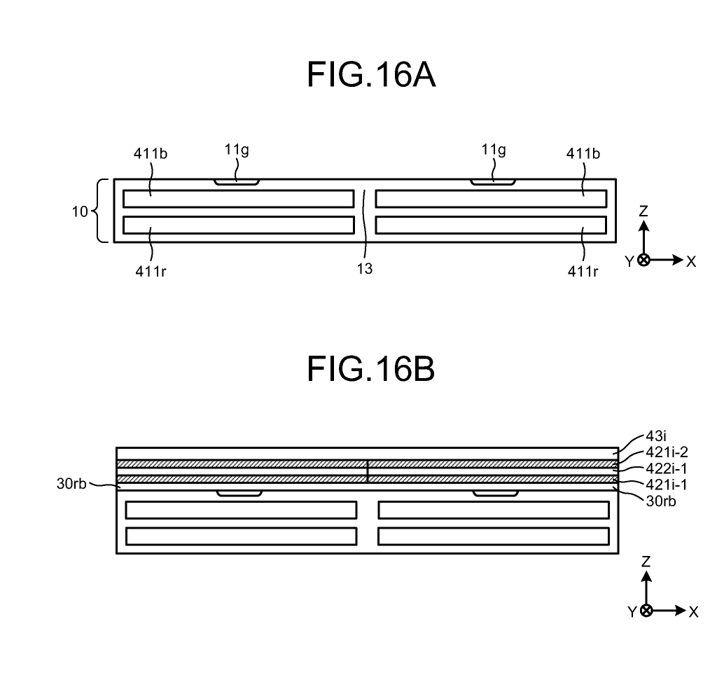

Further, a method of manufacturing the solid-state imaging device 405 is different from that according to the first embodiment in terms of the following as illustrated in FIGS. 16A and 16B. FIGS. 16A and 16B are cross-sectional views illustrating processes of the method of manufacturing the solid-state imaging device 405.

In a process illustrated in FIG. 16A, the semiconductor substrate 10 is prepared and the well region 13 is formed in the semiconductor substrate 10 by an ion implantation method or the like. The well region 13 is made of a semiconductor (for example, silicon) that contains the first conductive type (for example, P type) impurity with a low concentration. The P type impurity is, for example, boron. Further, the charge holding unit 11g and the photoelectric conversion units 411b and 411r are formed in the well region 13 by an ion implantation method or the like. The charge holding unit 11g and the photoelectric conversion units 411b and 411r are made of a semiconductor (for example, silicon) that contains the second conductive type (for example, N type) impurity, of which the conductive type is opposite to the first conductive type, with a concentration higher than the concentration of the first conductive type impurity of the well region 13. The N type impurity is, for example, phosphorus or arsenic. Furthermore, acceleration voltages at the time of ion implantation (implantation energy) are adjusted so that the photoelectric conversion unit 411b is formed at a position deeper than the position of the charge holding unit 11g and the photoelectric conversion unit 411r is formed at a position deeper than the position of the photoelectric conversion unit 411b.

In a process illustrated in FIG. 16B, an interlayer insulating film 30rb is deposited on the semiconductor substrate 10 by a CVD method or the like. Next, the formation of the respective layers, which form the multilayer interference filter 420rb, is started. Specifically, a first insulating layer 421-1, a second insulating layer 422-1, and a first insulating layer 421-2 are deposited in this order by a sputtering method or the like.

The first insulating layers 421-1 and 421-2 are made of, for example, titanium oxide (TiO₂). Each of the first insulating layers 421-1 and 421-2 is formed so as to have a physical thickness that corresponds to an optical thickness larger than a quarter of the center wavelength (for example, 550 nm). When each of the first insulating layers 421-1 and 421-2 is made of titanium oxide (having a refractive index of 2.5), each of the first insulating layers 421-1 and 421-2 is formed so as to have a physical thickness (for example, 64 nm) that is larger than 55 (nm) (=550×¼× 1/2.5).

The second insulating layer 422-1 is made of, for example, silicon oxide (SiO₂). The second insulating layer 422-1 is formed so as to have a physical thickness that corresponds to an optical thickness smaller than a quarter of the center wavelength (for example, 550 nm). When the second insulating layer 422-1 is made of silicon oxide (having a refractive index of 1.45), the second insulating layer 422-1 is formed so as to have a physical thickness (for example, 41 nm) smaller than 94.8 (nm) (≈550×¼× 1/1.45).

After that, similar processes to the processes, which have been performed in FIG. 6D or later, are performed.

As described above, in the fourth embodiment, the reflective unit 170 is disposed on the side surfaces 420rb1 to 420rb4 of the multilayer interference filter 420rb in each of respective pixels P401 and P402 of the solid-state imaging device 405, and covers the side surfaces 420rb1 to 420rb4 of the multilayer interference filter 420rb. Accordingly, for example, in the pixel P401, the reflective unit 170 can reflect green light, which has been multiply reflected in the multilayer interference filter 420rb and reached the side surfaces 420rb1 to 420rb4, so that the green light is returned to the multilayer interference filter 420rb from the side surfaces 420rb1 to 420rb4. As a result, it is possible to prevent green light from leaking to the photoelectric conversion film 63g of the adjacent pixel P402, and to efficiently reflect the light, which corresponds to a green wavelength region, by the multilayer interference filter 420rb and the reflective unit 170 to guide the light to the photoelectric conversion film 63g of the pixel P401. Accordingly, even when the organic photoelectric conversion film is made thin to meet a demand for the reduction of a voltage, it is possible to efficiently guide light to the organic photoelectric conversion film while suppressing the mixing of colors between the pixels. Therefore, it is possible to improve the sensitivity of the organic photoelectric conversion film.

Further, in the fourth embodiment, in each of the pixels P401 and P402 of the solid-state imaging device 405, the multilayer interference filter 420rb selectively guides the second color (blue) light and the third color (red) light of light, which has passed through the photoelectric conversion unit 60g, to the photoelectric conversion units 411b and 411r, and reflects the first color (green) light to guide the first color light to the photoelectric conversion unit 60g. Accordingly, it is possible to efficiently guide light to the photoelectric conversion film 63g of the photoelectric conversion unit 60g while making each pixel correspond to three colors.

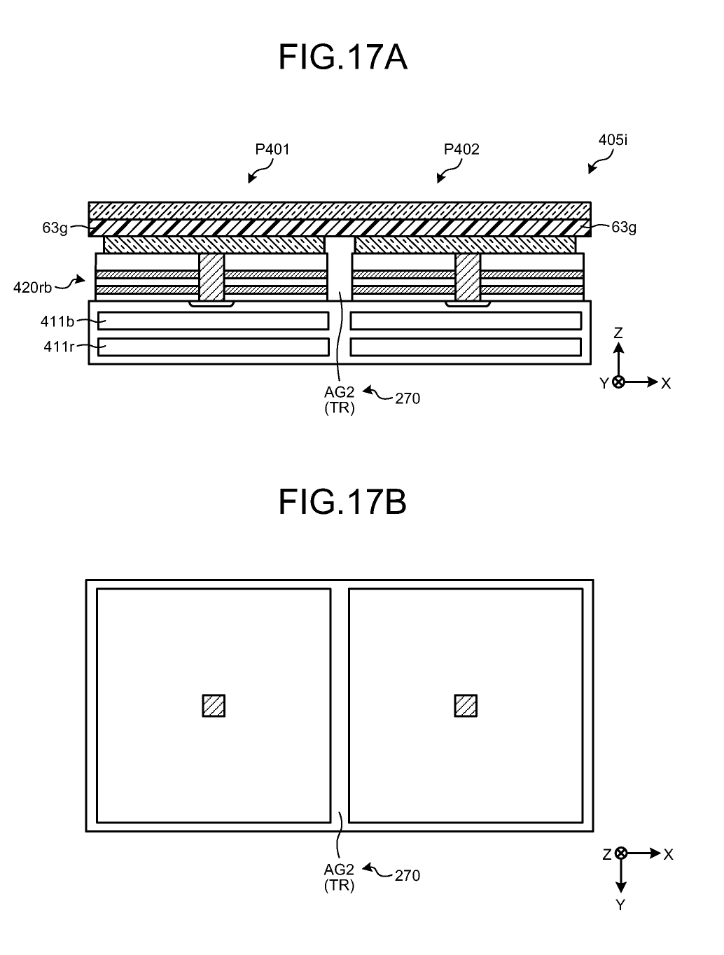

Meanwhile, the reflective unit 270, which includes the air gap structure AG2 and has been illustrated in the second embodiment, may be applied to the fourth embodiment as illustrated in FIGS. 17A and 17B. FIGS. 17A and 17B are diagrams illustrating the structure of a solid-state imaging device 405i according to a modification of the fourth embodiment. Even in this case, it is possible to prevent green light from leaking to the photoelectric conversion film 63g of the adjacent pixel P402, and to efficiently reflect the light, which corresponds to a green wavelength region, by the multilayer interference filter 420rb and the reflective unit 270 to guide the light to the photoelectric conversion film 63g of the pixel P401. Accordingly, even when the organic photoelectric conversion film is made thin to meet a demand for the reduction of a voltage, it is possible to efficiently guide light to the organic photoelectric conversion film while suppressing the mixing of colors between the pixels. Therefore, it is possible to improve the sensitivity of the organic photoelectric conversion film.

Further, in each of the pixels P401 and P402 of the solid-state imaging device 405i, the multilayer interference filter 420rb selectively guides the second color (blue) light and the third color (red) light of light, which has passed through the photoelectric conversion unit 60g, to the photoelectric conversion units 411b and 411r, and reflects the first color (green) light to guide the first color light to the photoelectric conversion unit 60g. Accordingly, it is possible to efficiently guide light to the photoelectric conversion film 63g of the photoelectric conversion unit 60g while making each pixel correspond to three colors.

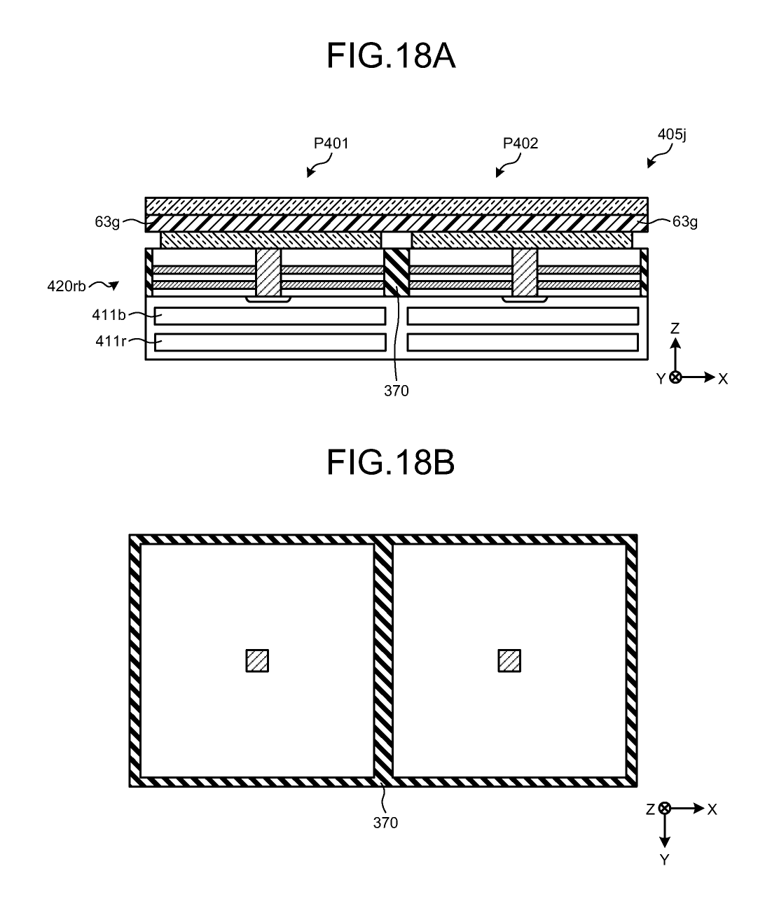

Alternatively, the reflective unit 370, which is made of an insulating material and has been illustrated in the third embodiment, may be applied to the fourth embodiment as illustrated in FIGS. 18A and 18B. FIGS. 18A and 18B are diagrams illustrating the structure of a solid-state imaging device 405j according to another modification of the fourth embodiment. Even in this case, it is possible to prevent green light from leaking to the photoelectric conversion film 63g of the adjacent pixel P402, and to efficiently reflect the light, which corresponds to a green wavelength region, by the multilayer interference filter 420rb and the reflective unit 370 to guide the light to the photoelectric conversion film 63g of the pixel P401. Accordingly, even when the organic photoelectric conversion film is made thin to meet a demand for the reduction of a voltage, it is possible to efficiently guide light to the organic photoelectric conversion film while suppressing the mixing of colors between the pixels. Therefore, it is possible to improve the sensitivity of the organic photoelectric conversion film.

Furthermore, in each of the pixels P401 and P402 of the solid-state imaging device 405j, the multilayer interference filter 420rb selectively guides the second color (blue) light and the third color (red) light of light, which has passed through the photoelectric conversion unit 60g, to the photoelectric conversion units 411b and 411r, and reflects the first color (green) light to guide the first color light to the photoelectric conversion unit 60g. Accordingly, it is possible to efficiently guide light to the photoelectric conversion film 63g of the photoelectric conversion unit 60g while making each pixel correspond to three colors.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A solid-state imaging device comprising:
a plurality of pixels,
wherein each of the plurality of pixels includes
a first photoelectric conversion unit that includes a photoelectric conversion film photoelectrically converting first color light,
a second photoelectric conversion unit,
a multilayer interference filter in which first and second layers having different refractive indexes are alternately laminated and which selectively guides at least second color light of light having passed through the first photoelectric conversion unit to the second photoelectric conversion unit, and
a reflective unit that is disposed on a side surface of the multilayer interference filter.

2. The solid-state imaging device according to claim 1,
wherein the multilayer interference filter selectively guides at least the second color light to the second photoelectric conversion unit, and reflects the first color light to guide the first color light to the first photoelectric conversion unit, of the light having passed through the first photoelectric conversion unit.

3. The solid-state imaging device according to claim 1,
wherein the reflective unit covers the side surface of the multilayer interference filter.

4. The solid-state imaging device according to claim 1,
wherein the reflective unit is disposed so as to surround the multilayer interference filter when viewed in a direction perpendicular to a light receiving surface of the photoelectric conversion film.

5. The solid-state imaging device according to claim 1,
wherein the reflective unit is disposed in boundary regions of two adjacent pixels and is shared between the two adjacent pixels.

6. The solid-state imaging device according to claim 5,
wherein the reflective unit for the plurality of pixels extends in the shape of a lattice so as to define boundaries of the pixels when viewed in a direction perpendicular to a light receiving surface of the photoelectric conversion film.

7. The solid-state imaging device according to claim 1,
wherein the reflective unit is configured by embedding a conductive material in a trench forming the side surface of the multilayer interference filter.

8. The solid-state imaging device according to claim 7,
wherein the trench is formed so as to surround the multilayer interference filter when viewed in a direction perpendicular to a light receiving surface of the photoelectric conversion film.

9. The solid-state imaging device according to claim 7,
wherein the reflective unit is connected to a ground potential.

10. The solid-state imaging device according to claim 7,
wherein the first photoelectric conversion unit further includes a pixel electrode film that covers a main surface of the photoelectric conversion film in a side of the second photoelectric conversion unit, and
the reflective unit is configured to be electrically insulated from the pixel electrode film.

11. The solid-state imaging device according to claim 10,
wherein the reflective unit has a pattern that surrounds the pixel electrode film without overlapping the pixel electrode film when viewed in a direction perpendicular to a light receiving surface of the photoelectric conversion film.

12. The solid-state imaging device according to claim 1,
wherein the reflective unit is configured by embedding an insulating material having a refractive index which is different from the refractive index of the first layer and the refractive index of the second layer, in a trench forming the side surface of the multilayer interference filter.

13. The solid-state imaging device according to claim 12,
wherein the trench is formed so as to surround the multilayer interference filter when viewed in a direction perpendicular to a light receiving surface of the photoelectric conversion film.

14. The solid-state imaging device according to claim 1,
wherein the reflective unit is configured by an air gap structure where a trench forming the side surface of the multilayer interference filter is filled with gas.

15. The solid-state imaging device according to claim 14,
wherein the trench is formed so as to surround the multilayer interference filter when viewed in a direction perpendicular to a light receiving surface of the photoelectric conversion film.

16. The solid-state imaging device according to claim 15,
wherein the first photoelectric conversion unit further includes a pixel electrode film that covers a main surface of the photoelectric conversion film in a side of the second photoelectric conversion unit, and
the pixel electrode film has a pattern that matches a pattern of the reflective unit when viewed in a direction perpendicular to a light receiving surface of the photoelectric conversion film.

17. The solid-state imaging device according to claim 16,
wherein the air gap structure communicates with a void that electrically separates the pixel electrode film for the respective pixels.

18. The solid-state imaging device according to claim 1,
wherein each of the plurality of pixels further includes a color filter that is disposed on one side of the first photoelectric conversion unit opposite to the second photoelectric conversion unit and selectively guides the first color light and the second color light of incident light to the first photoelectric conversion unit.

19. The solid-state imaging device according to claim 1,
wherein each of the plurality of pixels further includes a third photoelectric conversion unit that is disposed on one side of the second photoelectric conversion unit opposite to the first photoelectric conversion unit, and
the multilayer interference filter selectively guides the second color light and third color light of light, having passed through the first photoelectric conversion unit, to the second photoelectric conversion unit and the third photoelectric conversion unit.

20. The solid-state imaging device according to claim 19,
wherein the second color light is light having a wavelength shorter than a wavelength of the first color light, and the third color light is light having a wavelength longer than the wavelength of the first color light,
the second photoelectric conversion unit is disposed in a semiconductor substrate,
the third photoelectric conversion unit is disposed in the semiconductor substrate at a position that is deeper than a position of the second photoelectric conversion unit,
the second photoelectric conversion unit photoelectrically converts the second color light, and
the third photoelectric conversion unit photoelectrically converts the third color light.
